(19) United States
(12) Patent Application Publication
(10) Pub. No.: US 2019/0011604 A1
(43) Pub. Date: Jan. 10, 2019

(54) LAMINATE, METHOD OF MANUFACTURING LAMINATE, AND METHOD OF MANUFACTURING ANTIREFLECTION FILM

(71) Applicant: FUJIFILM Corporation, Tokyo (JP)

(72) Inventors: Daiki WAKIZAKA, Kanagawa (JP); Shuntaro IBUKI, Kanagawa (JP); Yuta FUKUSHIMA, Kanagawa (JP); Miho ASAHI, Kanagawa (JP); Takayasu YAMAZAKI, Kanagawa (JP)

(73) Assignee: FUJIFILM Corporation, Tokyo (JP)

(21) Appl. No.: 16/129,050

(22) Filed: Sep. 12, 2018

Related U.S. Application Data
(63) Continuation of application No. PCT/JP2017/007252, filed on Feb. 24, 2017.

(30) Foreign Application Priority Data
Mar. 18, 2016 (JP) 2016-055449
May 23, 2016 (JP) 2016-102776

(51) Int. Cl. G02B 1/118; G02B 1/14; C08J 3/24; C08J 5/18; C08J 7/04; C09D 5/00

(52) U.S. Cl. CPC G02B 1/118; G02B 1/14; C09D 5/006; C08J 5/18; C08J 7/04; C08J 3/24

(57) ABSTRACT

A laminate includes: a substrate; a layer (ca) containing a resin; a particle (a2) having an average primary particle diameter of 100 nm to 380 nm; and a layer (b) containing a pressure sensitive adhesive having a gel fraction of 95.0% or more, the layer (ca) is present closer to the substrate than the layer (b), the particle (a2) is buried in a layer obtained by combining the layer (ca) and the layer (b) and protrudes from an interface of the layer (ca) on an opposite side of an interface of the layer (ca) on the substrate side, and a value obtained by subtracting a surface free energy (b) of a surface of the layer (b) from a surface free energy (ca) of a surface of the layer (ca) is −15 mN/m to 10 mN/m.

### CROSS REFERENCE TO RELATED APPLICATION

This is a continuation of International Application No. PCT/JP2017/007252 filed on Feb. 24, 2017, and claims priority from Japanese Patent Application No. 2016-055449 filed on Mar. 18, 2016 and Japanese Patent Application No. 2016-102776 filed on May 23, 2016, the entire disclosures of which are incorporated herein by reference.

### BACKGROUND OF THE INVENTION

### 1. Field of the Invention

The present invention relates to a laminate, a method of manufacturing a laminate, and a method of manufacturing an antireflection film.

### 2. Description of the Related Art

In an image display device such as a display device using a cathode ray tube (CRT), a plasma display panel (PDP), an electroluminescent display (ELD), a vacuum fluorescent display (VFD), a field emission display (FED), and a liquid crystal display (LCD), an antireflection film may be provided in order to prevent decrease in contrast due to reflection of external light on a display surface and reflected glare of an image. In addition to the image display device, the antireflection function may be provided to a glass surface of the showroom or the like by an antireflection film.

As the antireflection film, an antireflection film having a fine uneven shape with a period equal to or less than the wavelength of visible light on the surface of a substrate, that is, an antireflection film having a so-called moth eye structure is known. The moth eye structure makes a refractive index gradient layer in which the refractive index successively changes in a pseudo manner from the air toward the bulk material inside the substrate, and reflection of the light can be prevented.

As an antireflection film having a moth eye structure, JP2009-139796A discloses the antireflection film having a moth eye structure that is manufactured by a method of coating a transparent substrate with a coating liquid containing a transparent resin monomer and a fine particle, curing the coating liquid, forming a transparent resin in which a fine particle is dispersed, and then etching the transparent resin.

Further, JP2014-221554A discloses that a protective film is bonded to an antireflection film having a moth eye structure that is manufactured by using a die, such that the moth eye structure is protected from dirt and scratches.

### SUMMARY OF THE INVENTION

However, in the techniques of JP2009-139796A and JP2014-221554A, it is required to etch a transparent resin or manufacture a die, and thus a process of manufacturing an antireflection film becomes complicated.

An object of the present invention is to provide a laminate that can be used for easily manufacturing an antireflection film having a satisfactory antireflection performance, low haze, and small muddiness, a method of manufacturing the laminate, and a method of manufacturing an antireflection film using the method of manufacturing the laminate.

In order to solve the above problems, the inventors of the present invention have conducted research on the forming of a moth eye structure by applying a composition containing a particle and a curable compound on a substrate. However, in a case where the particle is exposed to an air interface during the period from coating to curing, the particle easily aggregates, and muddiness is caused in some cases. Accordingly, the present inventors have further conducted research to find that a satisfactory uneven shape formed with particle can be manufactured by laminating a layer including a pressure sensitive adhesive, not causing the particles to be exposed to the air interface during a period between the coating and hardening, and peeling off the layer including a pressure sensitive adhesive after curing.

That is, the present inventors have found that the above object can be achieved by the following means.

[1] A laminate comprising: a substrate; a layer (ca) including a resin; a particle (a2) having an average primary particle diameter of 100 nm to 380 nm; and a layer (b) including a pressure sensitive adhesive having a gel fraction of 95.0% or more,

in which the layer (ca) is present closer to the substrate than the layer (b).

the particle (a2) is buried in a layer obtained by combining the layer (ca) and the layer (b) and protrudes from an interface of the layer (ca) on an opposite side of an interface of the layer (ca) on the substrate side, and

a value obtained by subtracting a surface free energy (b) of a surface of the layer (b) from a surface free energy (ca) of a surface of the layer (ca) is −15 mN/m to 10 mN/m.

[2] The laminate according to [1], in which the surface free energy (ca) of the surface of the layer (ca) is 40 mN/m or less, and the surface free energy (b) of the surface of the layer (b) is 40 mN/m or less.

[3] The laminate according to [1] or [2], in which a contact angle of water on the surface of the layer (ca) is 50° or more.

[4] The laminate according to any one of [1] to [3], further comprising: a support on an interface of the layer (b) on an opposite side of an interface of the layer (b) on the layer (ca) side.

[5] The laminate according to any one of [1] to [4], in which a height of the interface of the layer (ca) on the opposite side of the interface of the layer (ca) on the substrate side is equal to or less than a half of an average primary particle diameter of the particles (a2).

[6] The laminate according to any one of [1] to [5], in which a plurality of the particles (a2) are not present in a direction orthogonal to a surface of the substrate.

[7] The laminate according to any one of [1] to [6], in which the particle (a2) is a metal oxide particle.

[8] The laminate according to any one of [1] to [7], in which the particle (a2) is a surface-modified particle.

[9] The laminate according to any one of [1] to [8], in which a lubricant having three or more crosslinking groups in one molecule, having a crosslinking group equivalent of 450 or less, and having a moiety including at least one of a fluorine atom or a siloxane bond is present between the layer (b) and the layer (ca).

[10] A method of manufacturing a laminate comprising, in order:

a step (1) of providing a curable compound (a1) and a particle (a2) having an average primary particle diameter of 100 nm to 380 nm on a substrate, in a thickness in which the particle (a2) is buried in a layer (a) including the curable compound (a1);

a step (2) of bonding a layer (b) of a pressure sensitive film having a support and the layer (b) including a pressure sensitive adhesive having a gel fraction of 95.0% or more on the support to the layer (a):

a step (3) of causing a position of an interface between the layer (a) and the layer (b) to descend to the substrate such that the particle (a2) is buried in a layer obtained by combining the layer (a) and the layer (b) and protrudes from an interface of the layer (a) on an opposite side of an interface of the layer (a) on the substrate side; and

a step (4) of curing the layer (a) in a state in which the particle (a2) is buried in the layer obtained by combining the layer (a) and the layer (b),

in which a value obtained by subtracting a surface free energy (b) of a surface of the layer (b) from a surface free energy (ca) of a surface of the cured layer (a) is −15 mN/m to 10 mN/m.

[11] The method of manufacturing a laminate according to [10], in which the surface free energy (ca) of the surface of the cured layer (a) is 40 mN/m or less.

[12] The method of manufacturing a laminate according to [10] or [11], in which the surface free energy (b) of the surface of the layer (b) is 40 mN/m or less.

[13] The method of manufacturing a laminate according to any one of [10] to [12], in which a maximum transmittance of the pressure sensitive film at a wavelength of 250 nm to 300 nm is 20% or more.

[14] The method of manufacturing a laminate according to any one of [10] to [13], in which the pressure sensitive adhesive includes a cured product of a pressure sensitive adhesive composition including a polymer and the crosslinking agent, and the pressure sensitive adhesive composition includes a crosslinking agent of more than 3.5 parts by mass and less than 15 parts by mass with respect to 100 parts by mass of the polymer.

[15] The method of manufacturing a laminate according to [14], in which a weight-average molecular weight of a sol component in the pressure sensitive adhesive is 10,000 or less.

[16] The method of manufacturing a laminate according to any one of [10] to [13], in which a storage modulus of elasticity of the pressure sensitive adhesive at 30° C. and 1 Hz is 1.3×10⁵ Pa or less, and a weight-average molecular weight of a sol component in the pressure sensitive adhesive is 10.000 or less.

[17] The method of manufacturing a laminate according to any one of [10] to [16], in which a compound having three or more (meth)acryloyl groups in one molecule is included as the curable compound (a1).

[18] The method of manufacturing a laminate according to any one of [10] to [17], in which the step (3) is performed by heating the laminate so as to cause a portion of the curable compound (a1) to permeate the substrate.

[19] The method of manufacturing a laminate according to [18], in which a temperature during the heating is 60° C. to 180° C.

[20] The method of manufacturing a laminate according to any one of [10] to [17], in which the step (3) is performed by causing a portion of the curable compound (a1) to permeate the layer (b).

[21] The method of manufacturing a laminate according to [20], in which a temperature at which the portion of the curable compound (a1) permeates the layer (b) is less than 60° C.

[22] A method of manufacturing an antireflection film comprising: a step (5) of peeling off the pressure sensitive film of the laminate obtained by the method of manufacturing a laminate according to any one of [10] to [21].

According to the present invention, it is possible to provide a laminate that can be used for easily manufacturing an antireflection film having a satisfactory antireflection performance, low haze, and small muddiness, a method of manufacturing the laminate, and a method of manufacturing an antireflection film using the method of manufacturing the laminate.

### BRIEF DESCRIPTION OF THE DRAWINGS

FIG. 1 is a schematic view illustrating an example for describing a method of manufacturing a laminate and a method of manufacturing an antireflection film according to the present invention.

FIG. 2 is a schematic cross-sectional view illustrating an example of an antireflection film manufactured by the manufacturing method of the present invention.

### DESCRIPTION OF THE PREFERRED EMBODIMENTS

[Method of Manufacturing Laminate]

A method of manufacturing a laminate of the present invention, including, in this order:

a step (1) of providing a curable compound (a1) and a particle (a2) having an average primary particle diameter of 100 nm to 380 nm on a substrate, in a thickness in which the particle (a2) is buried in a layer (a) including the curable compound (a1),

a step (2) of bonding a layer (b) of a pressure sensitive film having a support and the layer (b) including a pressure sensitive adhesive having a gel fraction of 95.0% or more on the support to the layer (a),

a step (3) of causing a position of an interface between the layer (a) and the layer (b) to descend (come close) to the substrate such that the particle (a2) is buried in a layer obtained by combining the layer (a) and the layer (b) and protrudes from an interface of the layer (a) on an opposite side of an interface of the layer (a) on the substrate side, and

a step (4) of curing the layer (a) in a state in which the particle (a2) is buried in a layer obtained by combining the layer (a) and the layer (b),

in which a value obtained by subtracting a surface free energy (b) of a surface of the layer (b) from a surface free energy (ca) of a surface of the cured layer (a) is −15 mN/m to 10 mN/m.

The method of manufacturing an antireflection film of the present invention has a step (5) of peeling off the pressure sensitive film of a laminate obtained by a method of manufacturing of a laminate of the present invention.

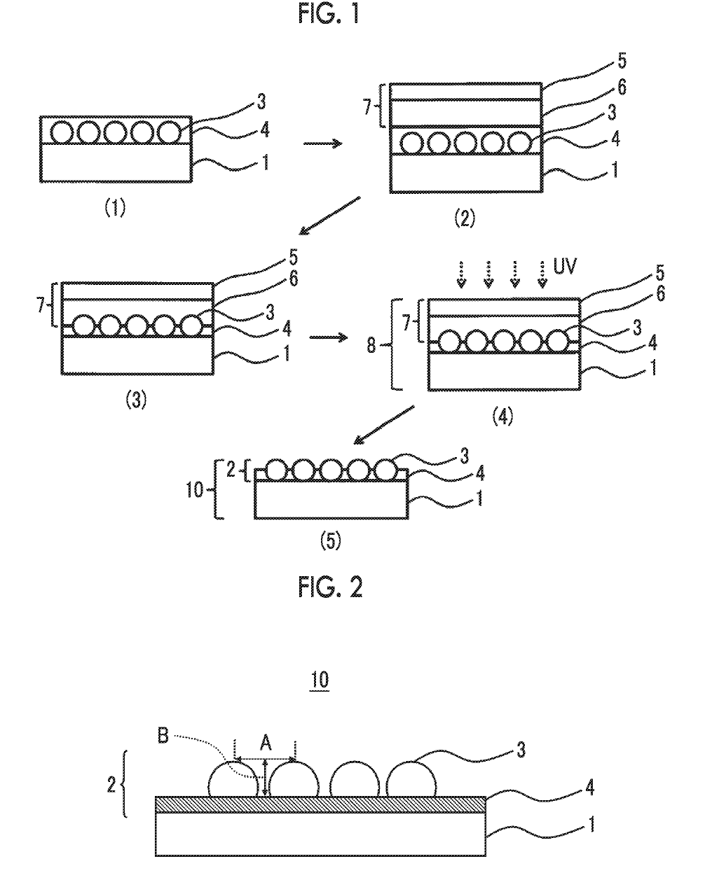

An example of a preferable embodiment of the method of manufacturing the laminate and the method of manufacturing the antireflection film according to the present invention is illustrated in FIG. 1.

(1) of FIG. 1 schematically illustrates a state in which the particle (a2) (reference numeral 3 in FIG. 1) having an average primary particle diameter of 100 nm to 380 nm in the layer (a) (reference numeral 4 in FIG. 1) including the curable compound (a1) is provided on a substrate 1 in the step (1) in a thickness in which the particle (a2) is buried.

(2) in FIG. 1 schematically illustrates a state in which the layer (b) of the pressure sensitive film 7 having a support 5 and a layer (b) (reference numeral 6 in FIG. 1) including a pressure sensitive adhesive having a gel fraction of 95.0% or more on the support 5 is bonded to the layer (a) (reference numeral 4 in FIG. 1) in the step (2).

(3) of FIG. 1 schematically illustrates a state in which a position of an interface between the layer (a) and the layer (b) is caused to descend to the substrate side, such that the particle (a2) is buried in a layer obtained by combining the layer (a) and the layer (b) and protrudes from an interface of the layer (a) on an opposite side of the interface of the layer (a) on the substrate, in the step (3). As described above, examples of the method of causing the position of the interface between the layer (a) and the layer (b) to descend to the substrate side include a method of causing a portion of the curable compound (a1) to permeate the substrate (in a case where the substrate has a functional layer, to permeate a functional layer) or a method of causing a portion of the curable compound (a1) to permeate the layer (b) including a pressure sensitive adhesive.

(4) of FIG. 1 schematically illustrates a case where the layer (a) is cured in a state in which the particle (a2) is buried in a layer obtained by combining the layer (a) and the layer (b) in the step (4).

A laminate 8 obtained completing the step (4) is a laminate of the present invention. The layer (a) (reference numeral 4) in the laminate 8 corresponds to a layer (ca) including a resin which is a cured product of the curable compound (a1).

(5) of FIG. 1 illustrates a state (antireflection film 10) after the pressure sensitive film 7 is peeled off in the step (5) of peeling off the pressure sensitive film 7 of the obtained laminate 8.

[Step (1)]

The step (1) is a step of providing the curable compound (a1) and the particle (a2) having an average primary particle diameter of 100 nm to 380 nm on the substrate, in a thickness in which the particle (a2) is buried in the layer (a) including the curable compound (a1).

According to the present invention, the expression “a thickness in which the particle (a2) is buried in the layer (a) including the curable compound (a1)” refers to a thickness of 0.8 times or more of an average primary particle diameter of the particles (a2).

In the step (1), a method of providing the layer (a) on the substrate is not particularly limited, but it is preferable to provide the layer (a) by coating the substrate with the layer (a). In this case, the layer (a) is a layer obtained by applying a composition (A) including the curable compound (a1) and the particle (a2) having an average primary particle diameter of 100 nm to 380 nm. The coating method is not particularly limited, and well-known methods can be used. Examples thereof include a dip coating method, an air knife coating method, a curtain coating method, a roller coating method, a wire bar coating method, a gravure coating method, and a die coating method.

In the step (1), it is preferable that a plurality of particles (a2) are not present in a direction orthogonal to the surface of the substrate. Here, the expression “the plurality of particles (a2) are not present in the direction orthogonal to the surface of the substrate” indicates that, in a case where 10 μm×10 μm of the in-plane of the substrate is observed with three visual fields with a scanning electron microscope (SEM), the proportion of the number of particles (a2) in a state in which a plurality of the particles are not present in the direction orthogonal to the surface is 80% or more and preferably 95% or more.

(Substrate)

The substrate is not particularly limited, as long as the substrate is a substrate having light transmittance that is generally used as a substrate of an antireflection film, but a plastic substrate or a glass substrate is preferable.

As the plastic substrate, various kinds thereof can be used. Examples thereof include a substrate containing a cellulose-based resin; cellulose acylate (triacetate cellulose, diacetyl cellulose, and acetate butyrate cellulose) and the like; a polyester resin; polyethylene terephthalate and the like, a (meth)acrylic resin, a polyurethane-based resin, polycarbonate, polystyrene, an olefin-based resin, and the like. A substrate containing cellulose acylate, polyethylene terephthalate, or a (meth)acrylic resin is preferable, a substrate containing cellulose acylate is more preferable, and a cellulose acylate film is particularly preferable. As the cellulose acylate, substrates and the like disclosed in JP2012-093723A can be preferably used.

The thickness of the plastic substrate is usually about 10 μm to 1,000 μm. However, in view of satisfactory handleability, high light transmittance, and sufficient strength, the thickness is preferably 20 μm to 200 μm and more preferably 25 μm to 100 μm. As the light transmittance of the plastic substrate, those having light transmittance of the visible light of 90% or more are preferable.

According to the present invention, before the step (1), a functional layer may be provided on the substrate. In a case where a functional layer is provided on the substrate, for convenience, a laminate of the functional layer and the substrate is called a “substrate”. In a case where a functional layer is provided on the substrate, the layer (a) is provided on the functional layer in the step (1) and subsequent steps are performed. As the functional layer, a hard coat layer is preferable.

(Layer (a))

The layer (a) includes the curable compound (a1) and the particle (a2) having an average primary particle diameter of 100 nm to 380 nm.

The layer (a) is a layer for forming an antireflection layer in the antireflection film (also referred to as a “completed antireflection film”) manufactured by the manufacturing method of the present invention.

The curable compound (a1) included in the layer (a) is cured to become a binder resin of the antireflection layer in the completed antireflection film.

The particle (a2) having an average primary particle diameter of 100 nm to 380 nm included in the layer (a) is a particle protruding from the surface of the film consisting of the binder resin in the completed antireflection film and having an uneven shape (moth eye structure).

The layer (a) is cured in the step (4), and thus components contained before curing and after curing are different, but according to the present invention, for convenience, the layer is referred to as the layer (a) at any stage.

The film thickness of the layer (a) in the step (1) is preferably 0.8 times to 2.0 times, more preferably 0.8 times to 1.5 times, and even more preferably 0.9 times to 1.2 times of an average primary particle diameter of the particle (a2).

<Curable Compound (a1)>

The curable compound (a1) is preferably a compound (preferably an ionizing radiation curable compound) having a polymerizable functional group. As the compound having a polymerizable functional group, various monomer oligomers, and polymers can be used. As the polymerizable functional group (polymerizable group), photopolymerizable, electron beam polymerizable, or radiation polymerizable groups are preferable. Among the groups, a photopolymerizable functional group is preferable.

Examples of the photopolymerizable functional group include a polymerizable unsaturated group (carbon-carbon unsaturated double bond group) such as a (meth)acryloyl group, a vinyl group, a styryl group, and an allyl group. Among the groups, a (meth)acryloyl group is preferable.

Specific examples of the compound having a polymerizable unsaturated group include (meth)acrylic acid diesters of alkylene glycol such as neopentyl glycol acrylate, 1,6-hexanediol (meth)acrylate, and propylene glycol di(meth)acrylate;

(meth)acrylic acid diesters of polyoxyalkylene glycol such as triethylene glycol di(meth)acrylate, dipropylene glycol di(meth)acrylate, polyethylene glycol di(meth)acrylate, and polypropylene glycol di(meth)acrylate;

(meth)acrylic acid diesters of polyhydric alcohol such as pentaerythritol di(meth)acrylate; and

(meth)acrylic acid diesters of an ethylene oxide or propylene oxide adduct such as 2,2-bis{4-(acryloxy.diethoxy)phenyl}propane, and 2-2-bis{4-(acryloxy.polypropoxy)phenyl} propane.

Epoxy (meth)acrylates, urethane (meth)acrylates, and polyester (meth)acrylates are also preferably used as a compound having a photopolymerizable functional group.

Among these, esters of polyhydric alcohol and (meth)acrylic acid are preferable. More preferably, it contains at least one polyfunctional monomer having three or more (meth)acryloyl groups in one molecule.

Examples thereof include pentaerythritol tetra(meth)acrylate, pentaerythritol tri(meth)acrylate, trimethylolpropane tri(meth)acrylate, ethylene oxide (EO)-modified trimethylolpropane tri(meth)acrylate, propylene oxide (PO)-modified trimethylolpropane tri(meth)acrylate, EO-modified phosphate tri(meth)acrylate, trimethylol ethane tri(meth)acrylate, ditrimethylolpropane tetra(meth)acrylate, dipentaerythritol tetra(meth)acrylate, dipentaerythritol penta (meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate, and caprolactone-modified tris(acryloxyethyl) isocyanurate.

Specific compounds of polyfunctional acrylate-based compounds having (meth)acryloyl groups include esterified products of polyol and (meth)acrylic acid such as KAYARAD DPHA, KAYARAD DPHA-2C, KAYARAD PET-30, KAYARAD TMPTA, KAYARAD TPA-320, KAYARAD TPA-330, KAYARAD RP-1040, KAYARAD T-1420, KAYARAD D-310, KAYARAD DPCA-20, KAYARAD DPCA-30, KAYARAD DPCA-60, and KAYARAD GPO-303 manufactured by Nippon Kayaku Co., Ltd., and V#3PA, V#400. V#36095D, V#1000, and V#1080 manufactured by Osaka Organic Chemical Industry Ltd. A trifunctional or higher functional urethane acrylate compound such as SHIKOH UV-1400B, SHIKOH UV-1700B, SHIKOH UV-6300B, SHIKOH UV-7550B, SHIKOH UV-7600B, SHIKOH UV-7605B, SHIKOH UV-7610B, SHIKOH UV-7620EA, SHIKOH UV-7630B, SHIKOH UV-7640B, SHIKOH UV-6630B, SHIKOH UV-7000B, SHIKOH UV-7510B, SHIKOH UV-7461TE, SHIKOH UV-3000B, SHIKOH UV-3200B, SHIKOH UV-3210EA. SHIKOH UV-3310EA, SHIKOH UV-3310B, SHIKOH UV-3500BA, SHIKOH UV-3520TL. SHIKOH UV-3700B, SHIKOH UV-6100B, SHIKOH UV-6640B, SHIKOH UV-2000B, SHIKOH UV-2010B, SHIKOH UV-2250EA, and SHIKOH UV-2750B (manufactured by Nippon Synthetic Chem Industry Co., Ltd.), UA-306 H, UA-306 I, UA-306 T, and UL-503 LN (manufactured by Kyoeisha Chemical Co., Ltd.), UNIDIC 17-806, UNIDIC 17-813, UNIDIC V-4030, and UNIDIC V-4000BA (manufactured by DIC Corporation), EB-1290K, EB-220, EB-5129, EB-1830, and EB-4858 (manufactured by Daicel-UCB Corporation), U-4HA, U-6HA, U-10HA, and U-15HA (manufactured by Shin Nakamura Chemical Co., Ltd.). HIGH-COAP AU-2010 and HIGH-COAP AU-2020 (manufactured by Tokushiki Co., Ltd.), ARONIX M-1960 (manufactured by Toagosei Co., Ltd.), ARTRESIN UN-3320HA, UN-3320HC, UN-3320HS, UN-904, and HDP-4T (manufactured by Negami Chemical Industrial Co., Ltd.), and trifunctional or higher functional polyester compounds such as ARONIX M-8100, M-8030, and M-9050 (manufactured by Toagosei Co., Ltd.), and KRM-8307 (manufactured by Daicel-Allnex Ltd.) can be suitably used. Particularly, DPHA and PET-30 are preferably used.

Examples thereof include a resin having three or more polymerizable functional groups, for example, a polyester resin having a relatively low molecular weight, a polyether resin, an acrylic resin, an epoxy resin, an urethane resin, an alkyd resin, a spiroacetal resin, a polybutadiene resin, and a polythiol polyene resin, or an oligomer or a prepolymer of a polyfunctional compound such as polyhydric alcohol.

Compounds disclosed in JP2005-76005A and JP2005-36105A, dendrimers such as SIRIUS-501 and SUBARU-501 (manufactured by Osaka Organic Chemical Industry Ltd.), and norbomene ring-containing monomers disclosed in JP2005-60425A can be used.

In order to obtain a strong film by bonding the particle (a2) and the curable compound (a1) to each other, a silane coupling agent having a polymerizable functional group may be used as the curable compound (a1).

Specific examples of a silane coupling agent having a polymerizable functional group include 3-(meth)acryloxypropyltrimethoxysilane, 3-(meth)acryloxypropylmethyldimethoxysilane, 3-(meth)acryloxypropyldimethylmethoxysilane, 3-(meth)acryloxypropylmethyldiethoxysilane, 3-(meth)acryloxypropyl triethoxysilane, 2-(meth)acryloxyethyltrimethoxysilane, 2-(meth)acryloxyethyltriethoxysilane, 4-(meth)acryloxybutyltrimethoxysilane, and 4-(meth)acryloxybutyltriethoxysilane. Specifically, KBM-503 and KBM-5103 (manufactured by Shin-Etsu Chemical Co., Ltd.) or silane coupling agents X-12-1048. X-12-1049, and X-12-1050 (manufactured by Shin-Etsu Chemical Co., Ltd.) disclosed in JP2014-123091A, a compound C3 represented by the following structural formula, and the like can be used.

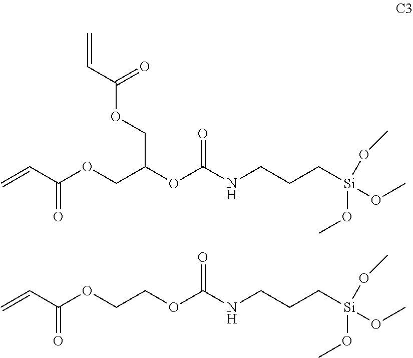

Two or more types of the compounds having a polymerizable functional group may be used in combination. The polymerization of these compounds having a polymerizable functional group can be performed by irradiation with ionizing radiation or heating under the presence of a photo-radical initiator or a thermal radical initiator.

The curable compound (a1) preferably includes at least one of the compounds having a (meth)acryloyl group having an SP value of 20 to 25, in view of permeation properties to the substrate. The SP value of the compound having a (meth)acryloyl group is preferably within ±4 and more preferably ±2 with respect to the SP value of the surface of the substrate.

The SP value (solubility parameter) in the present invention is a value calculated by the Hoy method, and the Hoy method is disclosed in POLYMER HANDBOOK FOURTH EDITION.

In view of easy permeation to a functional layer such as a plastic substrate or a hard coat layer, as the curable compound (a1), a compound having two or less polymerizable functional groups in one molecule may be used. Particularly, it is preferable that the compound having three or more polymerizable functional groups in one molecule and a compound having two or more polymerizable functional groups in one molecule or a compound not having a polymerizable functional group are used in combination.

The compound having two or more polymerizable functional groups in one molecule or a compound not having a polymerizable functional group is preferably a compound in which a weight-average molecular weight Mwa is 40<Mwa<500 and an SP value Spa by the Hoy method is 19<SPa<24.5. The compound having the molecular weight and the SP value is a compound that can easily permeate a plastic substrate (particularly, a cellulose acylate substrate) or a functional layer such as a hard coat layer and that is preferable for forming a permeation layer between the plastic substrate or a functional layer such as a hard coat layer and an antireflection layer. Since the number of the polymerizable functional groups is two or less or the polymerizable group is not included, constriction in a case of curing is small, and curling does not occur even in a case where the compound permeates the plastic substrate and cured.

The number of polymerizable functional groups in one molecule of the compound having two or less polymerizable functional groups in one molecule or the compound not having the polymerizable functional group is preferably 0 to 2 and more preferably 0 to 1.

The viscosity of the compound having two or more polymerizable functional groups in one molecule or the compound not having a polymerizable functional group at 25° C. is preferably 100 mPas or less and more preferably 1 to 50 mPas. The compound in this viscosity range is preferable since the compound easily permeates a plastic substrate or a functional layer such as a hard coat layer and also works so as to suppress aggregation of the particle (a2) such that haze and muddiness can be suppressed.

The compound having two or less polymerizable functional groups in one molecule preferably has a (meth)acryloyl group, an epoxy group, an alkoxy group, a vinyl group, a styryl group, and an allyl group as the polymerizable functional group.

As the compound not having a polymerizable functional group, an ester-based compound, an amine-based compound, an ether-based compound, an aliphatic alcohol-based compound, a hydrocarbon-based compound, and the like can be preferably used, and an ester-based compound is particularly preferable. More specific examples thereof include dimethyl succinate (SP value: 20.2, viscosity 2.6 mPas), diethyl succinate (SP value: 19.7, viscosity 2.6 mPas), dimethyl adipate (SP value: 19.7, viscosity 2.8 mPas), dibutyl succinate (SP value: 19.1, viscosity: 3.9 mPas), bis(2-butoxyethyl) adipate (SP value: 19.0, viscosity 10.8 mPas), dimethyl suberate (SP value: 19.4, viscosity: 3.7 mPas), diethyl phthalate (SP value: 22.3, viscosity: 9.8 mPas), dibutyl phthalate (SP value: 21.4, viscosity 13.7 mPas), triethyl citrate (SP value: 22.5, viscosity 22.6 mPas), acetyl triethyl citrate (SP value: 21.1, viscosity 29.7 mPas), and diphenyl ether (SP value: 21.4, viscosity 3.8 mPas).

The weight-average molecular weight and the number-average molecular weight according to the present invention are a value measured in the following conditions by the gel permeation chromatography (GPC).

### [Solvent] Tetrahydrofuran

### [Device Name] TOSOH HLC-8220GPC

[Column] Three items of TOSOH TSKgel Super HZM-H

(4.6 mm×15 cm) are linked to be used.

[Column temperature] 25° C.
[Sample concentration] 0.1 mass %
[Flow rate] 0.35 ml/min
[Calibration Curve] A calibration curve with seven samples of TSK standard polystyrene manufactured by TOSOH Corporation Mw=2,800,000 to 1,050 is used.

The coating amount of the curable compound (a1) included in the layer (a) is preferably 100 mg/m² to 800 mg/m², more preferably 100 mg/m² to 600 mg/m², and most preferably 100 mg/m² to 400 mg/m².

<Particle (a2) Having an Average Primary Particle Diameter of 100 nm to 380 nm>

The particle (a2) having an average primary particle diameter of 100 nm to 380 nm is referred to as the “particle (a2)”.

Examples of the particle (a2) include a metal oxide particle, resin particle, and an organic-inorganic hybrid particle having a core of a metal oxide particle and a shell of a resin. In view of excellent film hardness, the metal oxide particle is preferable.

Examples of the metal oxide particle include a silica particle, a titania particle, a zirconia particle, and an antimony pentoxide particle. Since the refractive index is close to many binders, haze is hardly generated and the moth eye structure is easily formed. Therefore, a silica particle is preferable.

Examples of the resin particle include a polymethyl methacrylate particle, a polystyrene particle, and a melamine particle.

In view of forming a moth eye structure by arranging a particle side by side, the average primary particle diameter of the particle (a2) is 100 nm to 380 nm, preferably 100 nm to 300 nm, more preferably 150 nm to 250 nm, and even more preferably 170 nm to 220 nm. Only one kind of the particle (a2) may be used singly, or two or more kinds of particles having different average primary particle diameters may be used.

The average primary particle diameter of the particle (a2) refers to the cumulative 50% particle diameter of the volume-average particle diameter. A scanning electron microscope (SEM) can be used to measure the particle diameter. A powder particle (in a case of a dispersion liquid, ones obtained by volatilizing a solvent by drying) is observed at the appropriate magnification (about 5000 times) by scanning electron microscope (SEM) observe, the diameter of each of 100 primary particles is measured, the volume thereof is calculated, and the cumulative 50% particle diameter can be taken as the average primary particle diameter. In a case where the particle is not spherical, the average value of the long diameter and the short diameter is regarded as the diameter of the primary particle. In a case where the particle contained in the antireflection film is measured, it is calculated by observing the antireflection film from the front surface side by SEM in the same manner as described above. In this case, for easier observation, carbon vapor deposition, an etching treatment, and the like may be suitably applied to the sample.

A shape of the particle (a2) is most preferably a spherical shape, but may be a shape other than a spherical shape such as an amorphous shape.

The silica particle may be crystalline or amorphous.

As the particle (a2), a surface-treated inorganic fine particle is preferably used for improving the dispersibility in the coating liquid, improving the film hardness, and preventing aggregation. Specific examples and preferable examples of the surface treatment method are the same as those described in [0119] to [0147] of JP2007-298974A.

Particularly, in view of providing the binding properties to the curable compound (a1) which is a binder component and improving the film hardness, it is preferable that the surface of the particle is surface-modified with a compound having a functional group having reactivity with an unsaturated double bond and the particle surface, and an unsaturated double bond is applied to the particle surface. As the compound used in the surface modification, a silane coupling agent having a polymerizable functional group described above as the curable compound (a1) can be appropriately used.

Specific examples of the particle having an average primary particle diameter of 100 nm to 380 nm include SEAHOSTAR KE-P10 (average primary particle diameter: 100 nm, amorphous silica manufactured by Nippon Shokubai Co., Ltd.), SEAHOSTAR KE-P30 (average primary particle diameter: 300 nm, amorphous silica manufactured by Nippon Shokubai Co., Ltd.), SEAHOSTAR KE-S30 (average primary particle diameter: 300 nm, heat resistance: 1,000° C., calcined silica manufactured by Nippon Shokubai Co., Ltd.), EPOSTAR S (average primary particle diameter: 200 nm, a melamine-formaldehyde condensate manufactured by Nippon Shokubai Co., Ltd.), EPOSTAR MA-MX100W (average primary particle diameter: 175 nm, polymethylmethacrylate (PMMA) crosslinked product manufactured by Nippon Shokubai Co., Ltd.), EPOSTAR MA-MX200W (average primary particle diameter: 350 nm, polymethylmethacrylate (PMMA) crosslinked product manufactured by Nippon Shokubai Co., Ltd.), STAFYROID (multilayer structure organic fine particle manufactured by Aica Kogyo Company. Limited), and GANZPEARL (polymethyl methacrylate, polystyrene particle manufactured by Aica Kogyo Company, Limited) can be preferably used.

Since the amount of hydroxyl groups on the surface is moderately large and the particle is hard, the particle (a2) is particularly preferably a calcined silica particle.

The calcined silica particle can be manufactured by a well-known technique of hydrolyzing and condensing a hydrolyzable silicon compound in an organic solvent including water and a catalyst to obtain a silica particle and calcining the silica particle, and, for example, JP2003-176121A and JP2008-137854A can be referred to.

The silicon compound as a raw material for manufacturing the calcined silica particle is not particularly limited, and examples thereof include a chlorosilane compound such as tetrachlorosilane, methyltrichlorosilane, phenyltrichlorosilane, dimethyldichlorosilane, diphenyldichlorosilane, methyl vinyl dichlorosilane, trimethylchlorosilane, and methyl diphenylchlorosilane; an alkoxysilane compound such as tetramethoxysilane, tetraethoxysilane, tetraisopropoxysilane, tetrabutoxysilane, methyltrimethoxysilane, methyltriethoxysilane, trimethoxyvinylsilane, triethoxyvinylsilane, 3-glycidoxypropyltrimethoxysilane, 3-chloropropyltrimethoxysilane, 3-mercaptopropyltrimethoxysilane, 3-(2-aminoethylamino) propyltrimethoxysilane, phenyltrimethoxysilane, phenyltriethoxysilane, dimethyl dimethoxysilane, dimethyl diethoxysilane, 3-glycidoxypropylmethyldimethoxysilane, 3-glycidoxypropylmethyldiethoxysilane, 3-chloropropylmethyldimethoxysilane, diphenyldimethoxysilane, diphenyldiethoxysilane, dimethoxydiethoxysilane, trimethylmethoxysilane, and trimethylethoxysilane; an acyloxysilane compound such as tetraacetoxysilane, methyl triacetoxysilane, phenyl triacetoxysilane, dimethyl diacetoxysilane, diphenyl diacetoxysilane, and trimethylacetoxysilane; and a silanol compound such as dimethylsilanediol, diphenylsilanediol, and trimethylsilanol. Among the exemplary silane compounds, an alkoxysilane compound is particularly preferable, since alkoxysilane compound can be obtained more easily and halogen atoms as impurities in the obtained calcined silica particle are not included. As a preferred embodiment of the calcined silica particle according to the present invention, it is preferable that the content of halogen atoms is substantially 0%, and halogen atoms are not detected.

The calcining temperature is not particularly limited, but is preferably 800° C. to 1,300° C. and more preferably 1,000° C. to 1,200° C.

The coating amount of the particle (a2) is preferably 50 mg/m² to 200 mg/m², more preferably 100 mg/m² to 180 mg/m², and most preferably 130 mg/m² to 170 mg/m². In a case where the coating amount is the lower limit or more, a large number of protrusions of the moth eye structure can be formed, and thus the antireflection properties are more easily improved. In a case where the coating amount is the upper limit or less, aggregation in the liquid hardly occurs and a satisfactory moth eye structure is easily formed.

It is preferable that only one kind of the monodispersed silica fine particle having an average primary particle diameter of 100 nm to 380 nm and having a Cv value of less than 5% is contained, since the height of the unevenness of the moth eye structure becomes homogeneous and the reflectivity is further decreased. The CV value is usually measured using a laser diffraction type particle diameter determination device, but other particle diameter measuring methods may be used, or particle size distribution can be calculated and obtained from the surface SEM image of the antireflection layer of the present invention by image analysis. The CV value is more preferably less than 4%.

The layer (a) may contain a component in addition to the curable compound (a1) and the particle (a2), and examples thereof include a solvent, a polymerization initiator, a dispersing agent of the particle (a2), a leveling agent, and an antifouling agent.

<Solvent>

In view of improving the dispersibility, it is preferable to select a solvent having a polarity close to that of the particle (a2). Specifically, for example, in a case where the particle (a2) is a metal oxide particle, an alcohol-based solvent is preferable, and examples thereof include methanol, ethanol, 2-propanol, 1-propanol, and butanol. For example, in a case where the particle (a2) is a metal resin particle subjected to hydrophobic surface modification, ketone-based, ester-based, carbonate-based, alkane, aromatic solvents, and the like are preferable, and examples thereof include methyl ethyl ketone (MEK), dimethyl carbonate, methyl acetate, acetone, methylene chloride, and cyclohexanone. A plurality of these solvents may be mixed to be used without remarkably deteriorating the dispersibility.

<Dispersing Agent of Particle (a2)>

The dispersing agent of the particle (a2) lowers the cohesive force between the particles such that the particle (a2) can be easily arranged in a uniform manner. The dispersing agent is not particularly limited, but an anionic compound such as sulfuric acid salt and phosphoric acid salt, a cationic compound such as aliphatic amine salt and quaternary ammonium salt, a nonionic compound, and a polymer compound are preferable, and a polymer compound is more preferable since the polymer compound has a high degree of freedom in selecting adsorptive groups and steric repulsive groups. As the dispersing agent, a commercially available product can be used. Examples thereof include DISPERBYK160, DISPERBYK161, DISPERBYK162, DISPERBYK163, DISPERBYK164, DISPERBYK66, DISPERBYK167, DISPERBYK171, DISPERBYK180, DISPERBYK182, DISPERBYK2000, DISPERBYK2001, DISPERBYK2164, Bykumen, BYK-2009, BYK-P104, BYK-P104S, BYK-220S, Anti-Terra203, Anti-Terra204, and Anti-Terra205 (all are trade names) manufactured by BYK Japan KK.

<Leveling Agent>

The leveling agent lowers the surface tension of the layer (a), such that the liquid after coating is stabilized and the curable compound (a1) and the particle (a2) can be easily arranged in a uniform manner.

A composition for forming the layer (a) used in the present invention can contain at least one leveling agent.

Accordingly, it is possible to suppress film thickness unevenness and the like caused by drying unevenness due to local distribution of drying air, to improve cissing of a coated product, or to easily arrange the curable compound (a1) and the particles (a2) in a uniform manner.

As the leveling agent, specifically, at least one leveling agent selected from a silicone-based leveling agent and a fluorine-based leveling agent can be used. The leveling agent is preferably an oligomer or polymer rather than a low molecular compound.

In a case where a leveling agent is added, a leveling agent rapidly moves to the surface of the applied coating film and is unevenly distributed, and thus the leveling agent is unevenly distributed on the surface as it is even after the coating film is dried. Therefore, the surface free energy of the film to which the leveling agent is added decreases due to the leveling agent. In view of preventing film thickness unevenness, cissing, and unevenness, it is preferable that the surface free energy of the film is low.

Preferable examples of the silicone-based leveling agent include a polymer or an oligomer including a plurality of dimethylsilyloxy units as repeating units and having substituents at a terminal and/or a side chain. A polymer or an oligomer including dimethylsilyloxy as repeating units may include a structural unit in addition to dimethylsilyloxy. The substituent may be identical to or different from each other and it is preferable to include a plurality of substituents. Examples of preferred substituents include groups including a polyether group, an alkyl group, an aryl group, an aryloxy group, an aryl group, a cinnamoyl group, an oxetanyl group, a fluoroalkyl group, a polyoxyalkylene group, or the like.

The number-average molecular weight of the silicone-based leveling agent is not particularly limited, and the number-average molecular weight is preferably 100,000 or less, more preferably 50,000 or less, even more preferably 1,000 to 30,000, and particularly preferably 1,000 to 20,000.

Examples of preferable silicone-based leveling agents include X22-3710, X22-162C, X22-3701E, X22160AS, X22170DX, X224015, X22176DX, X22-176F, X224272, KF8001, and X22-2000 manufactured by Shin-Etsu Chemical Co., Ltd.; FM4421, FM0425, FMDA26, FS1265, and the like manufactured by Chisso Corporation; BY16-750, BY16880, BY16848, SF8427, SF8421, SH3746, SH8400, SF3771, SH3749, SH3748, and SH8410 manufactured by Dow Corning Corporation; and TSF series (TSF4460, TSF4440, TSF4445, TSF4450, TSF4446, TSF4453, TSF4452, TSF4730, TSF4770, and the like), FGF502, SILWET series (SILWETL77, SILWETL2780, SILWETL7608, SILWETL7001, SILWETL7002, SILWETL7087, SILWETL7200, SILWETL7210, SILWETL7220, SILWETL7230, SILWETL7500, SILWETL7510, SILWETL7600, SILWETL7602, SILWETL7604, SILWETL7604, SILWETL7605, SILWETL7607, SILWETL7622, SILWETL7644, SILWETL7650, SILWETL7657, SILWETL8500, SILWETL8600, SILWETL8610, SILWETL8620, and SILWETL720) manufactured by Momentive Performance Materials Inc, as commercially available silicone-based leveling agents not having an ionizing radiation curing group, but the present invention is not limited thereto.

Examples of the silicone-based leveling agents having ionizing radiation curing groups include X22-163A, X22-173DX, X22-163C, KF101, X22164A, X24-8201, X22174DX, X22164C, X222426, X222445, X222457, X222459, X22245, X221602, X221603, X22164E, X22164B, X22164C, X22164D, and TM0701 manufactured by Shin-Etsu Chemical Co., Ltd., Silaplane series (FM0725, FM0721, FM7725, FM7721, FM7726, FM7727, and the like) manufactured by Chisso Corporation; SF8411, SF8413, BY16-152D, BY16-152, BY16-152C, 8388A, and the like manufactured by Dow Corning Corporation; TEGORad2010, 2011, 2100, 2200N, 2300, 2500, 2600, 2700, and the like manufactured by Evonik Japan Co., Ltd., BYK3500 manufactured by BYK Japan K.K.; KNS5300 manufactured by Shin-Etsu Chemical Co., Ltd.; and UVHC1105, UVHC8550, and the like manufactured by Momentive Performance Materials Inc., but the present invention is not limited thereto.

The content of the leveling agent is preferably 0.01 to 5.0 mass %, more preferably 0.01 to 2.0 mass %, and most preferably 0.01 to 1.0 mass % with respect to the total solid content of the composition for forming the layer (a).

The fluorine-based leveling agent is a compound of a fluoroaliphatic group and an amphipathic group that contributes to affinity for various compositions for coating or molding materials, and the like in a case where this leveling agent is used as an additive in the same molecule, and this compound can generally be obtained by copolymerizing a monomer having a fluoroaliphatic group and a monomer having a hydrophilic group.

Representative examples of the monomer having an amphiphilic group copolymerized with a monomer having a fluoroaliphatic group include poly(oxyalkylene) acrylate and poly(oxyalkylene) methacrylate.

As preferable commercially available fluorine-based leveling agents, examples of the leveling agent not having an ionizing radiation curing group include MEGAFACE series (MCF350-5, F472, F476, F445, F444, F443, F178, F470, F475, F479, F477, F482. F486, TF1025, F478, F178K, F-784-F, and the like) manufactured by DIC Corporation; and FTERGENT series (FTX218, 250, 245M, 209F, 222F, 245F, 208G, 218G, 240G, 206D, 240D, and the like) manufactured by NEOS Co., Ltd., and examples of the leveling agent having an ionizing radiation curing group include OPTOOL DAC manufactured by Daikin Industries, Ltd.; and DEFENSA series (TF3001, TF3000, TF3004, TF3028, TF3027, TF3026, TF3025, and the like) and RS series (RS71, RS101, RS102, RS103, RS104, RS105, and the like) manufactured by DIC Corporation, but the present invention is not limited thereto.

Compounds disclosed in JP2004-331812A and JP2004-163610A can be used.

<Antifouling Agent>

For the purpose of providing properties such as antifouling properties, water resistance, chemical resistance, and sliding properties, well-known silicone-based or fluorine-based antifouling agent, lubricant, or the like can be appropriately added to the layer (a).

As the specific examples of the silicone-based or fluorine-based antifouling agent, leveling agents having an ionizing radiation curing group among the silicone-based or fluorine-based leveling agents described above can be appropriately used, but the present invention is not limited thereto.

The content of the antifouling agent is preferably 0.01 to 5.0 mass %, more preferably 0.01 to 2.0 mass %, and most preferably 0.01 to 1.0 mass % with respect to the total solid content of the antifouling agent in the layer (a).

<Polymerization Initiator>

A polymerization initiator may be used in the layer (a).

In a case where the curable compound (a1) is a photopolymerizable compound, it is preferable to include a photopolymerization initiator.

Examples of the photopolymerization initiator include acetophenones, benzoins, benzophenones, phosphine oxides, ketals, anthraquinones, thioxanthones, an azo compound, peroxides, 2,3-dialkyldione compounds, disulfide compounds, fluoroamine compounds, aromatic sulfoniums, lophine dimers, onium salts, borate salts, active esters, active halogens, an inorganic complex, and coumarins. Specific examples, preferable embodiments, commercially available products and the like of the photopolymerization initiator are disclosed in paragraphs [0133] to [0151] of JP2009-098658A and can be appropriately used in the present invention in the in the same manner.

Various examples are provided in “Newest UV curing technology” {Technical Information Institute Co. Ltd.} (1991), page 159 and “Ultraviolet Curing System” written by Kiyomi KATO (published in 1989 by The Integrated Technology Center), pages 65 to 148, and are useful in the present invention.

The content of the polymerization initiator in the layer (a) is an amount sufficient for polymerizing the polymerizable compound included in the layer (a) and is preferably 0.1 to 8 mass % and more preferably 0.5 to 5 mass % with respect to the total solid content in the layer (a) such that the starting point does not excessively increase.

For the reaction of the silane coupling agent having a polymerizable functional group described above, a compound that generates an acid or a base by light or heat (hereinafter, sometimes referred to as a photoacid generator, a photobase generator, a thermal acid generator, or a thermal base generator) may be included in the layer (a).

<Photoacid Generator>

Examples of the photoacid generator include onium salt such as diazonium salt, ammonium salt, phosphonium salt, iodonium salt, sulfonium salt, selenonium salt, and an arsonium salt, an organohalogen compound, organometallic/organic halide, a photoacid generator having an o-nitrobenzyl-based protecting group, a compound that is photolyzed to generate sulfonic acid and is represented by iminosulfonate and the like, a disulfone compound, diazoketosulfone, and a diazodisulfone compound. Examples thereof also include triazines (for example, 2-(4-methoxyphenyl)-4,6-bis(trichloromethyl)-1,3,5-triazine, and the like), quaternary ammonium salts, a diazomethane compound, an imide sulfonate compound, and an oxime sulfonate compound.

A group that generates an acid by light or a compound obtained by introducing a compound into a main chain or a side chain of a polymer can be used.

Compounds that generate acid by light which are disclosed in V. N. R Pillai, Synthesis, (1), 1 (1980), A. Abad et al., Tetrahedron Lett., (47) 4555 (1971), D. H. R. Barton et al., J. Chem. Soc., (C), 329 (1970), U.S. Pat. No. 3,779,778A, and EP126,712B can be used.

<Thermal Acid Generator>

Examples of the thermal acid generator include salt consisting of an acid and an organic base.

Examples of the acid described above include organic acid such as sulfonic acid, phosphonic acid, and carboxylic acid and inorganic acid such as sulfuric acid and phosphoric acid. In view of compatibility with the curable compound (a1), organic acid is more preferable, sulfonic acid and phosphonic acid are more preferable, and sulfonic acid is most preferable. Preferable examples of sulfonic acid include p-toluenesulfonic acid (PTS), benzenesulfonic acid (BS), p-dodecylbenzenesulfonic acid (DBS), p-chlorobenzenesulfonic acid (CBS), 1,4-naphthalenedisulfonic acid (NDS), methanesulfonic acid (MsOH), and nonafluorobutane-1-sulfonic acid (NFBS).

As specific examples of the acid generator, acid generators disclosed in JP2016-803A can be appropriately used.

<Photobase Generator>

Examples of the photobase generator include a substance that generates bases by the action of active energy rays. More specifically, (1) a salt of organic acid and a base which is decomposed by decarburization by irradiation with ultraviolet rays, visible light, or infrared rays, (2) a compound decomposed by intramolecular nucleophilic substitution reaction or dislocation reaction to emit amines, or (3) a substance which causes some chemical reaction by irradiation with ultraviolet rays, visible light, or infrared rays to emit a base can be used.

The photobase generator used in the present invention is not particularly limited, as long as the photobase generator is a substance that generates a base by the action of active energy rays such as ultraviolet rays, electron beams, X rays, infrared rays, and visible light.

Specifically, photobase generators disclosed in JP2010-243773A can be appropriately used.

The content of the compound that generates an acid or a base by light or heat in the layer (a) is an amount sufficient for polymerizing the polymerizable compound included in the layer (a) and is preferably 0.1 to 8 mass % and more preferably 0.1 to 5 mass % with respect to the total solid content in the layer (a) such that the starting point does not excessively increase.

[Step (2)]

The step (2) is a step of bonding the layer (b) of the pressure sensitive film having a support and the layer (b) consisting of the pressure sensitive adhesive having gel fraction of 95.0% or more on the support to the layer (a).

The method of bonding the layer (a) and the layer (b) of the pressure sensitive film is not particularly limited, and well-known methods may be used. Examples thereof include a lamination method.

It is preferable to bond a pressure sensitive film such that the layer (a) and the layer (b) are in contact with each other.

Before the step (2), a step of drying the layer (a) may be provided. The drying temperature of the layer (a) is preferably 20° C. to 60° C. and more preferably 20° C. to 40° C. The drying time is preferably 0.1 to 120 seconds and more preferably 1 to 30 seconds.

According to the present invention, it has been found that the layer (b) of the pressure sensitive film and the layer (a) are bonded to each other in the step (2), the particle (a2) is buried in the layer obtained by combining the layer (a) and the layer (b) in the step (3), the particle (a2) is caused to protrude from an interface of the layer (a) on an opposite side of the interface of the layer (a) on the substrate side, the layer (a) is cured in a state in which the particle (a2) is buried in the layer obtained by combining the layer (a) and the layer (b) in the step (4) described below, such that the particle (a2) is not exposed to an air interface of the layer (a) before curing, and aggregation is suppressed, so as to manufacture a satisfactory uneven shape formed by the particle (a2).

It is preferable to manufacture an antireflection film by peeling off the pressure sensitive film after the laminate of the present invention is manufactured.

(Pressure Sensitive Film)

The pressure sensitive film has a support and the layer (b) consisting of a pressure sensitive adhesive having a gel fraction of 95.0% or more.

<Layer (b)>

The layer (b) consists of a pressure sensitive adhesive having a gel fraction of 95.0% or more.

In a case where the gel fraction of the pressure sensitive adhesive is 95.0% or more, in a case where the pressure sensitive film is peeled off from the laminate of the present invention to manufacture the antireflection film, it is possible to obtain the antireflection film in which a component of the pressure sensitive adhesive hardly remains on a surface of the antireflection film even in a case where washing is not performed, and reflectance is sufficiently low.

The gel fraction of the pressure sensitive adhesive is more preferably in the range of 95.0% to 99.9%, even more preferably in the range of 97.0% to 99.9%, and particularly preferably in the range of 98.0% to 99.9%.

The gel fraction of the pressure sensitive adhesive is a proportion of an insoluble matter after the pressure sensitive adhesive is immersed in tetrahydrofuran (THF) at 25° C. for 12 hours and is obtained from the following formula.

Gel fraction=(mass of insoluble matter of pressure sensitive adhesive in THF)/(total mass of pressure sensitive adhesive)×100(%)

The weight-average molecular weight of the sol component in the pressure sensitive adhesive is preferably 10,000 or less, more preferably 7,000 or less, and most preferably 5,000 or less. By setting the weight-average molecular weight of the sol component within the above range, the component of the pressure sensitive adhesive can be caused to hardly remain on the surface of the antireflection film in a case where the pressure sensitive film is peeled off from the laminate of the present invention to manufacture an antireflection film.

The sol component of the pressure sensitive adhesive represents a dissolution amount in THF after the pressure sensitive adhesive is immersed in tetrahydrofuran (THF) at 25° C. for 12 hours. The weight-average molecular weight can be analyzed by gel permeation chromatography (GPC).

It is also preferable that a storage modulus of elasticity (G′) of the pressure sensitive adhesive at 30° C. and 1 Hz is 1.3×10⁵ Pa or less, and the weight-average molecular weight of the sol component in the pressure sensitive adhesive is 10,000 or less.

The storage modulus of elasticity (G′) of the pressure sensitive adhesive at 30° C. and 1 Hz is more preferably 0.1×10⁵ Pa to 1.3×10⁵ Pa and even more preferably 0.1×10⁵ Pa to 1.2×10⁵ Pa. In a case where the storage modulus of elasticity is 0.1×10⁵ Pa or more, aggregation fracture of the pressure sensitive adhesive hardly occurs and handling is easy. In a case where the storage modulus of elasticity is 1.3×10⁵ Pa or less, the pressure sensitive adhesive easily enters the gaps between the particles, and thus an effect of suppressing of aggregation of the particle may be easily obtained. Therefore, in a case where the storage modulus of elasticity is 1.2×10⁵ Pa or less, it is possible to obtain the antireflection film having a satisfactory reflectance.

The preferable range of the weight-average molecular weight of the sol component in the pressure sensitive adhesive in this case is as described above.

The film thickness of the layer (b) is preferably 0.1 μm to 50 μm, more preferably 1 μm to 30 μm, and even more preferably 1 μm to 20 μm.

The layer (b) is preferably a pressure sensitive adhesive layer having a slight pressure sensitive adhesive strength in which a peeling strength (pressure sensitive adhesive strength) to a surface of an adherend at a peeling rate of 0.3 m/min is about 0.03 to 0.3 N/25 mm, since handleability in a case of peeling off the pressure sensitive film from the layer (a) which is the adherend is excellent.

The pressure sensitive adhesive preferably includes a polymer and more preferably includes a (meth)acrylic polymer. Particularly, a polymer (in a case where two or more kinds of monomers, a copolymer) of at least one monomer of (meth)acrylic acid alkyl ester monomers having an alkyl group of 1 to 18 carbon atoms is preferable. The weight-average molecular weight of the (meth)acrylic copolymer is preferably 200,000 to 2,000,000.

Examples of the (meth)acrylic acid alkyl ester monomer in which an alkyl group has 1 to 18 carbon atoms include an alkyl (meth)acrylate monomer such as methyl (meth)acrylate, ethyl (meth)acrylate, propyl (meth)acrylate, butyl (meth)acrylate, isobutyl (meth)acrylate, pentyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, isononyl (meth)acrylate, decyl (meth)acrylate, cyclopentyl (meth)acrylate, cyclohexyl (meth)acrylate, isomyristyl (meth)acrylate, isocetyl (meth)acrylate, isostearyl (meth)acrylate, myristyl (meth)acrylate, cetyl (meth)acrylate, stearyl (meth)acrylate, tetradecyl (meth)acrylate, pentadecyl (meth)acrylate, hexadecyl (meth)acrylate, heptadecyl (meth)acrylate, and octadecyl (meth)acrylate. The alkyl group of the alkyl (meth)acrylate monomer may be linear, branched or cyclic. Two or more of the monomers may be used in combination.

Preferable examples of the (meth)acrylate monomer having an aliphatic ring include cyclopentyl (meth)acrylate, cyclohexyl (meth)acrylate, cycloheptyl (meth)acrylate, and isobornyl (meth)acrylate. Among these, cyclohexyl (meth)acrylate is particularly preferable.

The (meth)acrylic polymer is a copolymer consisting of at least one of (meth)acrylic acid alkyl ester monomers having an alkyl group of 1 to 18 carbon atoms and at least one of other copolymerizable monomers. In this case, examples of the other copolymerizable monomers include a copolymerizable vinyl monomer containing at least one group selected from a hydroxyl group, a carboxyl group, and an amino group, a copolymerizable vinyl monomer having a vinyl group, and an aromatic monomer.

Examples of the copolymerizable vinyl monomer containing a hydroxyl group include hydroxyl group-containing (meth)acrylate esters such as 2-hydroxyethyl (meth)acrylate, 2-hydroxypropyl (meth)acrylate, 3-hydroxypropyl (meth)acrylate, 4-hydroxybutyl (meth)acrylate, 6-hydroxyhexyl (meth)acrylate, and 8-hydroxyoctyl (meth)acrylate, and hydroxyl group-containing (meth)acrylamides such as N-hydroxy (meth)acrylamide, N-hydroxymethyl (meth)acrylamide, and N-hydroxyethyl (meth)acrylamide, and the copolymerizable vinyl monomer is preferably at least one selected from the group of these compounds.

It is preferable that the content of the copolymerizable vinyl monomer containing a hydroxyl group is 0.1 to 15 parts by mass with respect to 100 parts by mass of the (meth)acrylic polymer.

Examples of the copolymerizable vinyl monomer containing a carboxyl group include (meth)acrylic acid, itaconic acid, crotonic acid, maleic acid, fumaric acid, carboxyethyl (meth)acrylate, and carboxypentyl (meth)acrylate, and at least one selected from the group of these compounds is preferable.

The content of the copolymerizable vinyl monomer containing a carboxyl group is preferably 0.1 to 2 parts by mass with respect to 100 parts by mass of the (meth) acrylic copolymer.

Examples of the copolymerizable vinyl monomer containing an amino group include monoalkylaminoalkyl (meth)acrylate such as monomethylaminoethyl (meth)acrylate, monoethylaminoethyl (meth)acrylate, monomethyl aminopropyl (meth)acrylate, and monoethylaminopropyl (meth)acrylate.

Examples of the aromatic monomer include styrene in addition to aromatic group-containing (meth)acrylate esters such as benzyl (meth)acrylate and phenoxyethyl (meth)acrylate.

Examples of the copolymerizable vinyl monomer other than the above include various vinyl monomers such as acrylamide, acrylonitrile, methyl vinyl ether, ethyl vinyl ether, vinyl acetate, and vinyl chloride.

The pressure sensitive adhesive may include a cured product of a composition (also referred to as a pressure sensitive adhesive composition) for forming the pressure sensitive adhesive.

The pressure sensitive adhesive composition preferably includes the polymer and the crosslinking agent, and may be crosslinked by heat, ultraviolet rays (UV), or the like. The crosslinking agent is preferably one or more crosslinking agents selected from a compound group consisting of a difunctional or higher functional isocyanate-based crosslinking agent, a difunctional or higher functional epoxy-based crosslinking agent, and an aluminum chelate-based crosslinking agent. In a case where a crosslinking agent is used, in order to cause the component of the pressure sensitive adhesive not to remain on the surface of the antireflection film in a case where the pressure sensitive film is peeled off from the laminate of the present invention to manufacture the antireflection film, the content of the crosslinking agent is preferably 0.1 to 15 parts by mass, more preferably 3.5 to 15 parts by mass, even more preferably more than 3.5 parts by mass and less than 15 parts by mass, and particularly preferably 5.1 to 10 parts by mass with respect to 100 parts by mass of the polymer.

The difunctional or higher functional isocyanate compound may be a polyisocyanate compound having at least two isocyanate (NCO) groups in one molecule, and examples thereof include a burette-modified product and an isocyanurate-modified product of diisocyanates (compounds having two NCO groups in one molecule) such as hexamethylene diisocyanate, isophorone diisocyanate, diphenylmethane diisocyanate, tolylene diisocyanate, and xylylene diisocyanate, and an adduct (polyol modified product) with trivalent or higher valent polyols (compounds having at least three OH groups in one molecule) such as trimethylolpropane and glycerin.

A trifunctional or higher functional isocyanate compound is a polyisocyanate compound having at least three or more isocyanate (NCO) groups in one molecule, and at least one or more selected from the compound group consisting of an isocyanurate body of a hexamethylene diisocyanate compound, an isocyanurate body of an isophorone diisocyanate compound, an adduct of hexamethylene diisocyanate compound, an adduct of isophorone diisocyanate compound, a burette body of a hexamethylene diisocyanate compound, and a burette body of an isophorone diisocyanate compound are preferable.

The difunctional or higher functional isocyanate-based crosslinking agent is contained in an amount of preferably 0.01 to 5.0 parts by mass and more preferably 0.02 to 3.0 parts by mass, with respect to 100 parts by mass of the acrylic copolymer.

The pressure sensitive adhesive composition may contain an antistatic agent in order to provide antistatic performances. The antistatic agent is preferably an ionic compound and more preferably quaternary onium salt.

As the antistatic agent which is a quaternary onium salt, for example, an alkyldimethylbenzyl ammonium salt having an alkyl group having 8 to 18 carbon atoms, a dialkylmethylbenzyl ammonium salt having an alkyl group having 8 to 18 carbon atoms, a trialkylbenzyl ammonium salt having an alkyl group having 8 to 18 carbon atoms, a tetraalkyl ammonium salt having an alkyl group having 8 to 18 carbon atoms, an alkyldimethylbenzyl phosphonium salt having an alkyl group having 8 to 18 carbon atoms, a dialkylmethylbenzyl phosphonium salt having an alkyl group having 8 to 18 carbon atoms, a trialkylbenzyl phosphonium salt having an alkyl group having 8 to 18 carbon atoms, a tetraalkyl phosphonium salt having an alkyl group having 8 to 18 carbon atoms, an alkyl trimethyl ammonium salt having an alkyl group having 14 to 20 carbon atoms, and an alkyldimethyl ethyl ammonium salt having an alkyl group having 14 to 20 carbon atoms can be used. These alkyl groups may be alkenyl groups having an unsaturated bond.

Examples of the alkyl group having 8 to 18 carbon atoms include an octyl group, a nonyl group, a decyl group, a dodecyl group, a tridecyl group, a tetradecyl group, a pentadecyl group, a hexadecyl group, a heptadecyl group, and an octadecyl group. The alkyl group having 8 to 18 carbon atoms may be a mixed alkyl group derived from natural fats and oils. Examples of the alkenyl group having 8 to 18 carbon atoms include an octenyl group, a nonenyl group, a decenyl group, a dodecenyl group, a tridecenyl group, a tetradecenyl group, a pentadecenyl group, a hexadecenyl group, a heptadecenyl group, an octadecenyl group, an oleyl group, and a linoleyl group.

Examples of the alkyl group having 14 to 20 carbon atoms include a tetradecyl group, a pentadecyl group, a hexadecyl group, a heptadecyl group, an octadecyl group, a nonadecyl group, and an icosyl group. The alkyl group having 14 to 20 carbon atoms may be a mixed alkyl group derived from natural fats and oils. Examples of the alkenyl group having 14 to 20 carbon atoms include a tetradecenyl group, a pentadecenyl group, a hexadecenyl group, a heptadecenyl group, an octadecenyl group, an oleyl group, a linoleyl group, a nonadecenyl group, and an icosenyl group.

Examples of a counter anion of the quaternary onium salt include chloride (Cl⁻), bromide (Br⁻), methyl sulfate (CH₃OSO₃⁻), ethyl sulfate (C₂H₅OSO₃⁻), and paratoluene sulfonate (p-CH₃C₆H₄SO₃⁻).

Specific examples of the quaternary onium salt include dodecyl dimethyl benzyl ammonium chloride, dodecyl dimethyl benzyl ammonium bromide, tetradecyl dimethyl benzyl ammonium chloride, tetradecyldimethylbenzyl ammonium bromide, hexadecyl dimethyl benzyl ammonium chloride, hexadecyl dimethyl benzyl ammonium bromide, octadecyl dimethyl benzyl ammonium chloride, octadecyldimethylbenzyl ammonium bromide, trioctylbenzyl ammonium chloride, trioctylbenzyl ammonium bromide, trioctylbenzyl phosphonium chloride, trioctylbenzyl phosphonium bromide, tris(decyl)benzyl ammonium chloride, tris(decyl)benzyl ammonium bromide, tris(decyl)benzyl phosphonium chloride, tris(decyl)benzyl phosphonium bromide, tetraoctyl ammonium chloride, tetraoctyl ammonium bromide, tetraoctyl phosphonium chloride, tetraoctyl phosphonium bromide, tetranonyl ammonium chloride, tetranonyl ammonium bromide, tetranonyl phosphonium chloride, tetranonyl phosphonium bromide, tetrakis(decyl)ammonium chloride, tetrakis(decyl)ammonium bromide, tetrakis(decyl)phosphonium chloride, and tetrakis(decyl)phosphonium bromide.

“Tris(decyl)” and “tetrakis (decyl)” mean having 3 or 4 decyl groups which are alkyl groups having 10 carbon atoms and is different from a tridecyl group which is an alkyl group having 13 carbon atoms or a tetradecyl group which is an alkyl group having 14 carbon atoms.

As the antistatic agent, in addition to the above, nonionic, cationic, anionic, and amphoteric surfactants, ionic liquid, alkali metal salt, metal oxide, metal fine particles, a conductive polymer, carbon, a carbon nanotube can be used.

Examples of the nonionic surfactant include polyoxyethylene alkyl ethers, polyoxyethylene alkyl phenyl ethers, sorbitan fatty acid esters, polyoxyethylene sorbitan fatty acid esters, polyoxyethylene fatty acid esters, glycerin fatty acid esters, propylene glycol fatty acid esters, and polyoxyalkylene-modified silicones.

Examples of the anionic surfactant include monoalkyl sulfate, alkyl polyoxyethylene sulfates, alkylbenzenesulfonic acid salts, and monoalkyl phosphates.

Examples of the amphoteric surfactant include alkyldimethylamine oxide and alkylcarboxybetaine.

The ionic liquid is a non-polymeric substance including anions and cations and being liquid at room temperature (for example, 25° C.). Examples of the cation portion include a cyclic amidine ion such as an imidazolium ion, a pyridinium ion, an ammonium ion, a sulfonium ion, and a phosphonium ion. Examples of the anion portion include CₙH₂ₙ₊₁COO⁻, CₙF₂ₙ₊₁COO⁻, NO₃⁻, CₙF_{2n+I}SO₃⁻, (CₙF₂ₙ₊₁SO₂)₂N⁻, (CₙF₂ₙ₊₁SO₂)₃C⁻, PO₄²⁻, AlCl₄⁻, Al₂Cl₇⁻, ClO₄⁻, BF₄⁻, PF₆⁻, AsF₆⁻, and SbF₆⁻.

Examples of the alkali metal salt include metal salt consisting of lithium, sodium, and potassium. In order to stabilize ionic substances, a compound containing a polyoxyalkylene structure may be added.

The antistatic agent preferably contains 0.1 to 10 parts by mass with respect to 100 parts by mass of the polymer.

The pressure sensitive adhesive composition can further contain a polyether-modified siloxane compound having HLB of 7 to 15 as an antistatic aid.

HLB is a hydrophilic-lipophilic balance (hydrophilic lipophilicity ratio) defined, for example, by JIS (Japanese Industrial Standard) K3211 (surfactant term) and the like.

The pressure sensitive adhesive composition can further contain a crosslinking accelerator. In a case where the crosslinking accelerator is a polyisocyanate compound as a crosslinking agent, the crosslinking accelerator may be a substance, as long as the substance functions as a catalyst for the reaction (crosslinking reaction) between the copolymer and the crosslinking agent, and examples thereof include an amine-based compound such as tertiary amine, and an organometallic compound such as a metal chelate compound, an organotin compounds, an organic lead compound, organozinc compound. According to the present invention, the crosslinking accelerator is preferably a metal chelate compound or an organotin compound.

The metal chelate compound is a compound obtained by bonding one or more polydentate ligands L to the central metal atom M. The metal chelate compound may or may not have one or more monodentate ligands X bonded to the metal atom M. For example, a formula of a metal chelate compound having one metal atom M is represented by M(L)ₘ(X)ₙ, m≥1 and n≥0. In a case where m is 2 or more, m items of L's may be the same ligands or different ligands. In a case where n is 2 or more, n X's may be the same ligand or different ligands.

Examples of the metal atom M include Fe, Ni, Mn, Cr, V, Ti, Ru, Zn, Al, Zr, and Sn. Examples of the polydentate ligand L include β-diketone such as methyl acetoacetate, ethyl acetoacetate, octyl acetoacetate, oleyl acetoacetate, lauryl acetoacetate, β-ketoester such as stearyl acetoacetate, acetylacetone (also referred to as 2,4-pentanedione), 2,4-hexanedione, and benzoylacetone. These are ketoenol tautomeric compounds, and in the polydentate ligand L, enolate obtained by deprotonating enol (for example, acetylacetonate) may be used.

Examples of the monodentate ligand X include a halogen atom such as a chlorine atom and a bromine atom, an acyloxy group such as a pentanoyl group, a hexanoyl group, a 2-ethylhexanoyl group, an octanoyl group, a nonanoyl group, a decanoyl group, a dodecanoyl group, and an octadecanoyl group, an alkoxy group such as a methoxy group, an ethoxy group, an n-propoxy group, an isopropoxy group, and a butoxy group.

Specific examples of the metal chelate compound include tris(2,4-pentanedionato) iron (III), iron trisacetyl acetonate, titanium trisacetyl acetonate, ruthenium trisacetyl acetonate, zinc bisacetyl acetonate, aluminum trisacetyl acetonate, zirconium tetrakis acetyl acetonate, tris(2,4-hexanedionato) iron (III), bis(2,4-hexanedionato) zinc, tris(2,4-hexanedionato) titanium, tris(2,4-hexanedionato) aluminum, and tetrakis(2,4-hexanedionato) zirconium.

Examples of the organotin compound include dialkyl tin oxide, fatty acid salt of dialkyl tin, and fatty acid salt of stannous tin. A long-chain alkyl tin compound such as a dioctyl tin compound is preferable. Specific examples of the organic tin compound include dioctyltin oxide and dioctyltin dilaurate.

The content of the crosslinking accelerator is preferably 0.001 to 0.5 parts by mass with respect to 100 parts by mass of the copolymer.

It is preferable that, the laminate of the present invention has three or more crosslinking groups in one molecule on the surface of the layer (b) of the layer (ca) side, a crosslinking group equivalent is 450 or less, and a lubricant (hereinafter also referred to as a “lubricant a”) having a low friction portion consisting of fluorine or silicone is present.

In a case where the lubricant a is present on the surface of the layer (b) on the layer (ca) side, the layer (b) (pressure sensitive adhesive layer) is peeled off from the laminate of the present invention to obtain the antireflection film, it is possible to prevent the pressure sensitive adhesive in the layer (b) from remaining on (transferred to) the surface of the layer (ca).

(Lubricant a)

The lubricant a is described.

The lubricant a has three or more crosslinking groups in one molecule, has a crosslinking group equivalent of 450 or less, and has a region (hereinafter, this region is also referred to as a “low friction region”) including at least one of a fluorine atom or a siloxane bond.

Examples of the crosslinking group include a radical reactive group or a reactive group other than the radical reactive group, and a radical reactive group is preferable.

Examples of the radical reactive group include a group having an addition polymerizable unsaturated bond (for example, a (meth)acryloyl group, a (meth)acrylamide group, a (meth)acrylonitrile group, an allyl group, a vinyl group, a styrene structure, a vinyl ether structure, and an acetylene structure), —SH, —PH, SiH, —GeH, and a disulfide structure. A polymerizable functional group (a group having a polymerizable carbon-carbon unsaturated double bond) such as a (meth)acryloyl group, a vinyl group, a styryl group, and an allyl group is preferable. Among these, a (meth)acryloyl group and —C(O)OCH═CH₂ are preferable, and a (meth)acryloyl group is most preferable.

Examples of the reactive group other than the radical reactive group include an epoxy group, an amino group, a boronic acid group, a boronic acid ester group, an oxiranyl group, an oxetanyl group, a hydroxyl group, a carboxyl group, and an isocyanate group.

The crosslinking group equivalent of the lubricant a is a value obtained by dividing a molecular weight of the lubricant a by the number of crosslinking groups included in the lubricant a, and is 450 or less, more preferably 350 or less, and even more preferably 300 or less in view of film hardness after curing.

For example, the crosslinking group equivalent in the case where the crosslinking group is an acryloyl group or a methacryloyl group is referred to as an acryl equivalent.

The lubricant a is preferably a compound (a1) that has a crosslinking group and a low friction region in a side chain and has a weight-average molecular weight of 6,000 or more in view of the uneven distribution in the antireflection layer or a compound (a2) in which a crosslinking group is bonded to a low friction region directly or via a linking group and which has a weight-average molecular weight of less than 6,000 in view of the strength of the outermost surface.

The compound (a1) is preferably a polymer, and the weight-average molecular weight of the compound (a1) is preferably 6,000 to 100.000 and more preferably 8,000 to 80,000.

The compound (a2) is preferably a monomer or an oligomer, and the weight-average molecular weight of the compound (a2) is preferably 900 to 6,000 and more preferably 1,300 to 5,000.

The weight-average molecular weight of the lubricant a is obtained by the same method of the weight-average molecular weight of the curable compound (b).

In view of the chemical resistance and the durability, in the compound (a1), it is preferable that a crosslinking group is linked to a main chain via a C—C bond or a C—O bond.

In the same manner as the compound (a2), in view of the chemical resistance and the durability, it is preferable that the low friction region and the crosslinking group are bonded via a C—C bond or a C—O bond.

It is preferable that the compound (a1) has a repeating unit having a low friction region in a side chain and a repeating unit having a crosslinking group in a side chain.

As the repeating unit having a crosslinking group in a side chain, those disclosed in

of JP2009-79126A can be referred to.

It is preferable that the compound (a2) is

a compound having one group represented by Formula (M-2),

a compound having one group represented by Formula (M-3),

a compound having two groups represented by Formula (M-1),

a compound having two groups represented by Formula (M-2), or

a compound having two groups represented by Formula (M-3).

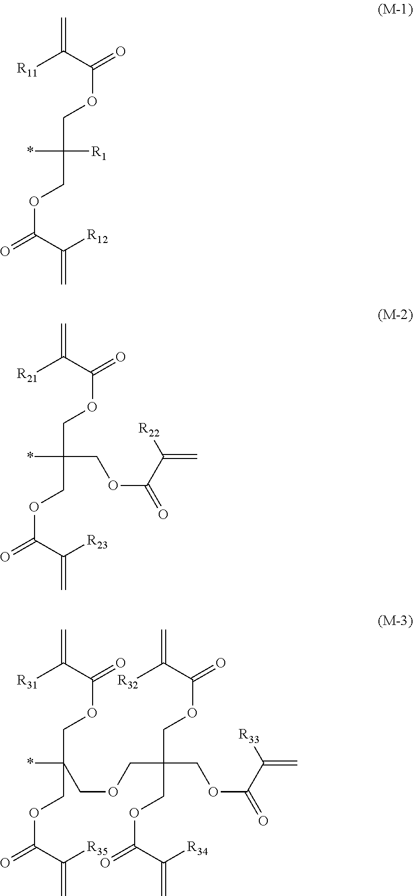

In Formula (M-1), R₁ represents a hydrogen atom, an alkyl group, an alkenyl group, an alkyloxy group, an alkenyloxy group, an alkyloxyalkyl group, or an alkenyloxyalkyl group, R₁₁ and R₁₂ each independently represent a hydrogen atom or a methyl group. * represents a bonding position.

In Formula (M-2), R₂₁ to R₂₃ each independently represent a hydrogen atom or a methyl group. * represents a bonding position.

In Formula (M-3), R₃₁ to R₃₅ each independently represent a hydrogen atom or a methyl group. * represents a bonding position.

In a case where the compound (a2) is a compound having one group represented by Formula (M-2), it is preferable that the group represented by Formula (M-2) which is a group having a crosslinking group is bonded to one terminal of a main chain including a low friction region directly or via a linking group.

In a case where the compound (a2) is a compound having one group represented by Formula (M-3), it is preferable that the group represented by Formula (M-3) which is a group having a crosslinking group is bonded to one terminal of a main chain including a low friction region directly or via a linking group.

In a case where the compound (a2) is a compound having two groups represented by Formula (M-1), it is preferable that the groups represented by Formula (M-1) which are groups having crosslinking groups are bonded to both terminals of the main chain including the low friction region directly or via linking groups. Here, two groups represented by Formula (M-1) may be identical to or different from each other.

In a case where the compound (a2) is a compound having two groups represented by Formula (M-2), it is preferable that the groups represented by Formula (M-2) which are groups having crosslinking groups are bonded to both terminals of a main chain including a low friction region directly or via linking groups. Here, two groups represented by Formula (M-2) may be identical to or different from each other.

In a case where the compound (a2) is a compound having two groups represented by Formula (M-3), it is preferable that the groups represented by Formula (M-3) which are groups having crosslinking groups are bonded to both terminals of the main chain including the low friction region directly or via linking groups. Here, two groups represented by Formula (M-3) may be identical to or different from each other.

In a case where the lubricant a has a low friction region including a fluorine atom, the region including a fluorine atom is preferably a fluoroalkyl group. For example, the lubricant a having a region including a fluorine atom can be represented by Formula (1), but the present invention is not limited thereto. According to the present invention, in the chemical formula, the hydrocarbon chain may be described by a simplified structural formula in which the symbols for carbon (C) and hydrogen (H) are omitted.

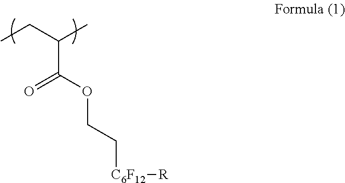

In Formula (1). R represents a hydrogen atom or a fluorine atom.

The structure of the siloxane bond in a case where the lubricant a has a low friction region including a siloxane bond is represented by Formula (P).

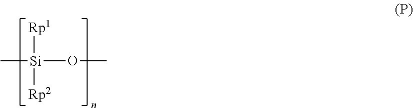

In Formula (P), Rp¹ and Rp² each independently represent a hydrogen atom, a monovalent hydrocarbon group, an alkoxy group, or an aryloxy group. n represents an integer of 2 or more.

Examples of the monovalent hydrocarbon group include an alkyl group, an aryl group, an alkenyl group, an alkynyl group, and an aralkyl group.

Rp¹ and Rp² each are preferably a hydrogen atom, a monovalent hydrocarbon group having 1 to 20 carbon atoms, an alkoxy group having 1 to 20 carbon atoms, or an aryloxy group having 6 to 20 carbon atoms, more preferably an alkyl group having 1 to 20 carbon atoms or an aryl group having 6 to 20 carbon atoms, even more preferably an alkyl group having 1 to 20 carbon atoms, and most preferably a methyl group.

n is preferably an integer of 6 to 100, n is more preferably an integer of 8 to 65, and n is most preferably an integer of 10 to 35.

As the region including a siloxane bond included in the lubricant a, polydimethylsiloxane group or a polyether-modified dimethylsiloxane group is useful. According to the present invention, a polydimethylsiloxane group or a polyether-modified dimethylsiloxane group which has a repeating number n of 6 to 100 is more preferable, and n is more preferably 8 to 65 and most preferably 10 to 35.

In a case where the repetition number n of the polydimethylsiloxane group or the polyether-modified dimethylsiloxane group is 6 or more, the hydrophobicity is exhibited, the uneven distribution properties to the air interface become strong, the low friction region can be exposed on the surface, and the polydimethylsiloxane group or the polyether-modified dimethylsiloxane group is not too short as a low friction region, so that the sliding properties can be improved. In a case where the repeating number n is 100 or less, the uneven distribution is sufficient, the density of the crosslinking groups is not reduced, the strength of the film obtained by crosslinking is increased, and the polydimethylsiloxane group or the polyether-modified dimethylsiloxane group effectively works for the scratch resistance test.

As the lubricant a having a region including a siloxane bond, a silicone-based polymer (the compound (A1)) and a silicone-based monomer or an oligomer (the compound (A2)) can be used. The compound (A1) and the compound (A2) are described below in detail.

<<Compound (A1)>>

The compound (A1) refers to a case where a low friction region is a region having a siloxane bond among the compounds (a1). That is, the compound (A1) is a compound (silicone-based polymer) having a region including a siloxane bond in a side chain and a crosslinking group and having a weight-average molecular weight of 6,000 or more. Specific examples of the compound (A1) are provided in Formula (2).

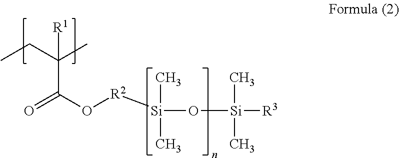

In Formula (2), R¹ represents a hydrogen atom or a methyl group, R² represents a divalent linking chain divalent linking chain, R³ represents a hydrogen atom or a monovalent organic group, and n represents an integer of 5 to 100. In each repeating unit, R¹, R², and R³ may be identical to or different from each other.

In Formula (2), R² represents a divalent linking chain, and specific examples of a substituted or unsubstituted alkylene group, a substituted or unsubstituted arylene group, a substituted or unsubstituted alkylene group having a linking group (for example, an ether bond, an ester bond, and an amide bond), and a substituted or unsubstituted arylene group having a linking group therein, a substituted or unsubstituted alkylene group, a substituted or unsubstituted arylene group, and an alkylene group having a linking group therein are preferable, an unsubstituted alkylene group, an unsubstituted arylene group, and an alkylene group having an ether bond or an ester bond therein are more preferable, and an unsubstituted alkylene group and an alkylene group having an ether bond or an ester bond therein are particularly preferable. Examples of the substituent include halogen, a hydroxyl group, a mercapto group, a carboxyl group, an epoxy group, an alkyl group, and an aryl group, and these substituents may be further substituted.

In Formula (2), n represents an integer of 5 to 100, preferably an integer of 7 to 65, and more preferably an integer of 9 to 35.

Among silicon-containing polymers (A) disclosed in paragraphs [0012] to [0048] of JP2009-79126A, P-10 and P-12 to P-14 in which the acryl equivalent satisfies the range of the present invention can be appropriately used as the lubricant a. Specific examples of the lubricant a having a siloxane bond are provided below, but the present invention is not limited thereto. In the following specific examples, the number appended to parentheses of each monomer unit represents a molar ratio of each monomer unit in a polymer.

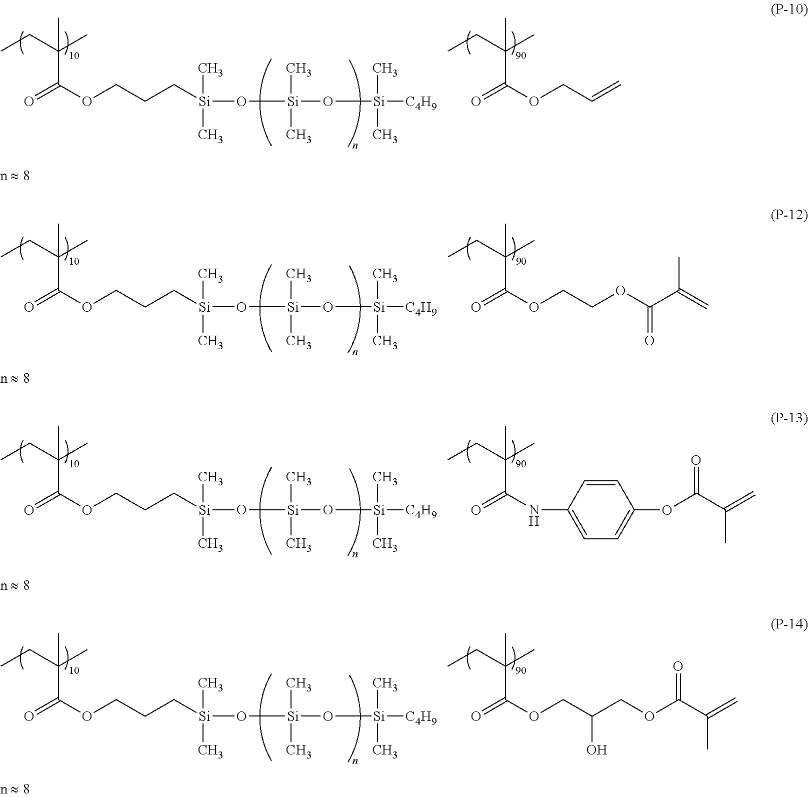

Examples of commercially available silicone polymers having a structure represented by Formula (2) include ACRIT 8SS-723 (manufactured by Taisei Fine Chemical Co., Ltd.) and ACRIT 8SS-1024 (manufactured by Taisei Fine Chemical Co., Ltd.).

<<Compound (A2)>>

The compound (A2) refers to a case where a low friction region is a region having a siloxane bond among the compounds (a2). That is, the compound (A2) is a compound (silicone-based monomer or oligomer) in which a crosslinking group is bonded to a region having a siloxane bond directly or via a linking group and which has a weight-average molecular weight of less than 6,000.

Examples of the silicone-based monomer or oligomer that can be appropriately used as the compound (A2) and that has a crosslinking group include a compound represented by Formula (4) and a compound represented by Formula (5), but the present invention is not limited thereto.

The compound represented by Formula (4) is a compound in which the group represented by Formula (M-3) which is the group having a crosslinking group is bonded to one terminal of the main chain including the low friction region via a linking group.

The compound represented by Formula (5) is a compound in which the group represented by Formula (M-2) which is a group having a crosslinking group is bonded to one terminal of a main chain including a low friction region via a linking group.

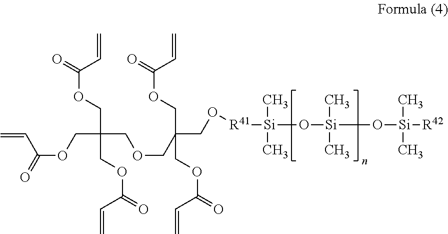

In Formula (4), R⁴¹ represents a divalent linking chain, R⁴² represents a hydrogen atom or a monovalent organic group, and n represents an integer of 4 to 100.

In Formula (4). R⁴¹ represents a divalent linking chain, and specific examples include a substituted or unsubstituted alkylene group, a substituted or unsubstituted arylene group, a substituted or unsubstituted alkylene group having a linking group (for example, an ether bond, an ester bond, and an amide bond) therein, and a substituted or unsubstituted arylene group having a linking group therein, a substituted or unsubstituted alkylene group, a substituted or unsubstituted arylene group, and an alkylene group having a linking group therein are preferable, an unsubstituted alkylene group, an unsubstituted arylene group, and an alkylene group having an ether bond or an ester bond therein are more preferable, and an unsubstituted alkylene group and an alkylene group having an ether bond or an ester bond therein are particularly preferable. Examples of the substituent include halogen, a hydroxyl group, a mercapto group, a carboxyl group, an epoxy group, an alkyl group, and an aryl group, and these substituents may be further substituted.

R⁴¹ in Formula (4) is preferably an unsubstituted alkylene group having an ether bond therein, more preferably *(CH₂)₃*.

R⁴² in Formula (4) represents a hydrogen atom or a monovalent organic group, and is preferably a hydrogen atom and a monovalent hydrocarbon group having 1 to 20 carbon atoms.

n in Formula (4) represents an integer of 4 to 100, preferably an integer of 6 to 65, and more preferably an integer of 8 to 35.

Specific examples of the compound represented by Formula (4) include compounds (S-1) and (S-2) below. However, the present invention is not limited thereto.

Compound (S-1): Compound in Formula (4), in which n is 10, R⁴¹ is —(CH₂)₃—, and R⁴² is CH₃.

Compound (S-2): Compound in Formula (4) in which n is 21, R⁴¹ is —(CH₂)₃—, and R⁴² is CH₃.

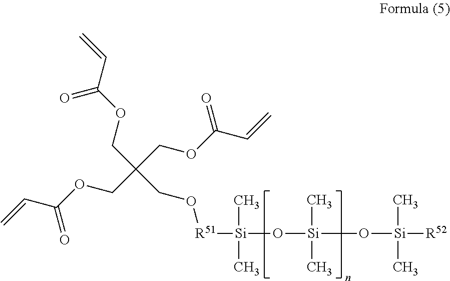

In Formula (5), R⁵¹ represents a divalent linking chain, R⁵² represents a hydrogen atom or a monovalent organic group, and n represents an integer of 2 to 100.

Specific examples and preferable ranges of R⁵¹ and R⁵² in Formula (5) are respectively the same as those of R⁴¹ and R⁴² in Formula (4).

The preferable range of n in Formula (5) is the same n in Formula (4).

Specific examples of the compound represented by Formula (5) include a compound (S-3) below. However, the present invention is not limited thereto.

Compound (S-3): Compound in Formula (5), in which n is 10, R⁵¹ is —(CH₂)₃—, and R⁵² is CH₃.

A compound (S-9) in Formula (4) which is a compound in which n is 10, R⁴¹ is —CONH(CH₂)₃—, and R⁴² is —CH₃ is preferable.

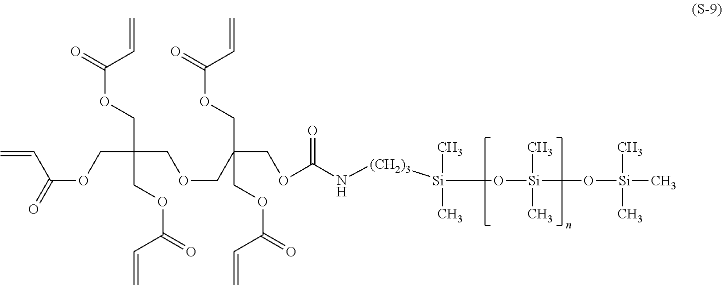

A compound (S-10) in Formula (5) which is a compound in which n is 10, R⁵¹ is —CONH(CH₂)₃—, and R⁵² is —CH₃ is also preferable.

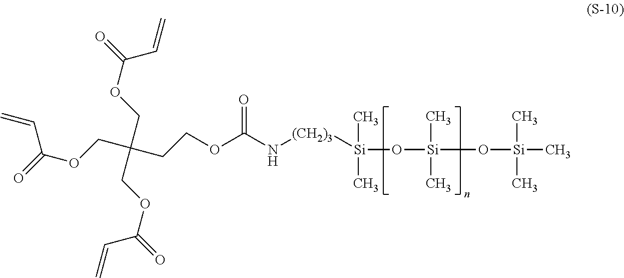

Examples of the silicone-based monomer or oligomer that can be appropriately used as the compound (A2) and that has a crosslinking group include a compound represented by Formula (6) and a compound represented by Formula (7) in addition to the compound represented by Formula (4) and the compound represented by Formula (5), but the present invention is not limited thereto.

The compound represented by Formula (6) is a compound in which the groups represented by Formula (M-3) which are the groups having a crosslinking group are bonded to both terminals of the main chain including the low friction region via linking groups.

The compound represented by Formula (6) is a compound in which the group represented by Formula (M-2) which is the group having the crosslinking group is bonded to one terminal of the main chain including a low friction region via a linking group, and the group represented by Formula (M-2) which is the group having the crosslinking group is bonded to the other terminal of the main chain including a low friction region via a linking group.

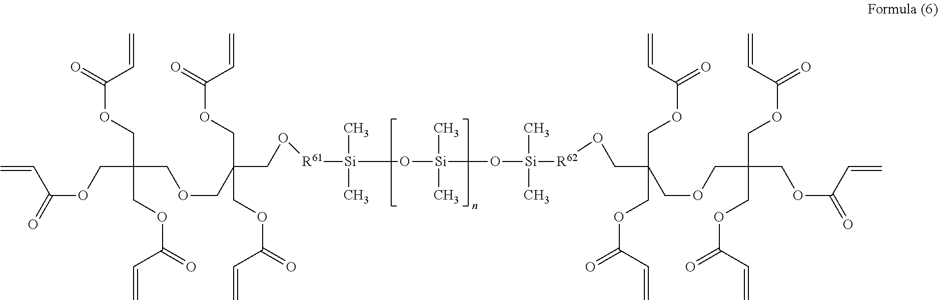

R⁶¹ and R⁶² in Formula (6) each independently represent a divalent linking chain, and n represents an integer of 4 to 100.

Specific examples and preferable ranges of R⁶¹ and R⁶² in Formula (6) are respectively the same as those of R⁴¹ in Formula (4).

The preferable range of n in Formula (6) is the same n in Formula (4).

Specific examples of the compound represented by Formula (6) include compounds (S-4) to (S-6) below. However, the present invention is not limited thereto.

Compound (S-4): Compound in Formula (6) in which n is 9, and R⁶¹ and R⁶² are —(CH₂)₃—.

Compound (S-5): Compound in Formula (6) in which n is 20, and R⁶¹ and R⁶² are —(CH₂)₃—.

Compound (S-6): Compound in Formula (6) in which n is 40, and R⁶¹ and R⁶² are —(CH₂)₃—.

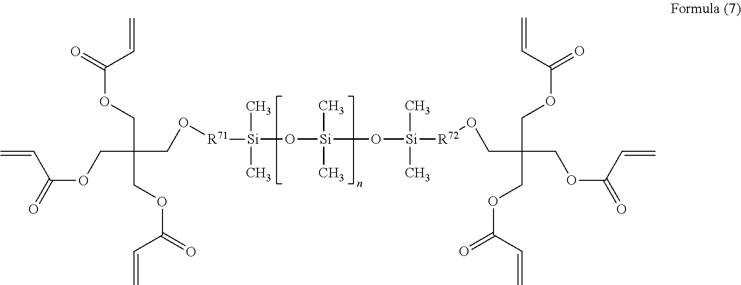

In Formula (7), R⁷¹ and R⁷² each independently represent a divalent linking chain, and n is an integer of 2 to 100.

Specific examples and preferable ranges of R⁷¹ and R⁷² in Formula (7) are respectively the same as those of R⁴¹ in Formula (4).

The preferable range of n in Formula (7) is the same n in Formula (4).

Specific examples of the compound represented by Formula (7) include compounds (S-7) and (S-8) below. However, the present invention is not limited thereto.

Compound (S-7): Compound in Formula (7) in which n is 20, and R⁷¹ and R⁷² are —(CH₂)₃—.

Compound (S-8): Compound in Formula (7) in which n is 40, and R⁷¹ and R⁷² are —(CH₂)₃—.

A compound (S-11) which is a compound in Formula (6) in which n is 10, and R⁶¹ and R⁶² are —CONH(CH₂)₃— is also preferable.

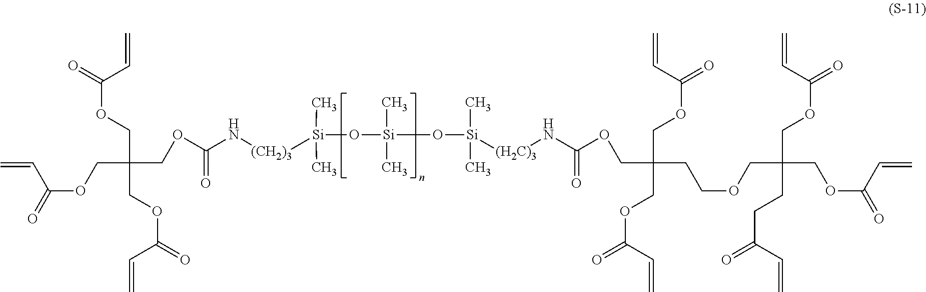

A compound (S-12) which is a compound in Formula (7) in which n is 10, and R⁷¹ and R⁷² are —CONH(CH₂)₃— is also preferable.

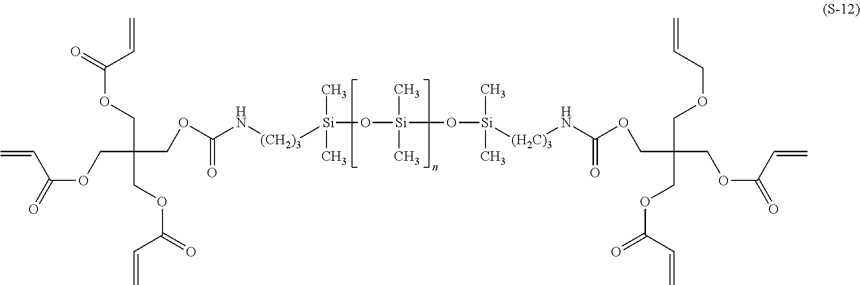

(Method of Providing Lubricant a)

The method of providing the lubricant a such that the lubricant a is present on the surface of the layer (b) on the layer (ca) side in the laminate of the present invention is not limited.

Examples of the method of providing the lubricant a include a method of adding the lubricant a to the composition for forming the layer (a) to form the layer (a).

According to the present invention, the providing method of the lubricant a described below is particularly preferable.

First, the lubricant a is applied to a polyethylene terephthalate (PET) film and dried to obtain a separator. Next, the surface coated with the lubricant a of the separator and the layer (b) side of the pressure sensitive film are bonded to each other, and the PET film is peeled off, so as to obtain a pressure sensitive film provided with the lubricant a on the surface of the layer (b). Thereafter, the layer (b) side of the pressure sensitive film provided with the lubricant a on the surface of the layer (b) and the layer (a) provided on the substrate are bonded to each other, and the steps (3) and (4) are performed, so as to obtain the laminate in which the lubricant a is present on the surface of the layer (b) on the layer (ca) side. The method of providing the lubricant a is preferable, since the lubricant a may be unevenly distributed on the surface of the layer (ca), and thus the surface free energy of the surface of the layer (ca) decreases, such that, in a case where the pressure sensitive film is peeled off, the pressure sensitive adhesive hardly remains on the layer (ca).

<Support>

The support in the pressure sensitive film is described.

As the support, a plastic film consisting of a resin having transparency and flexibility is preferably used. Preferable examples of the plastic film for the support include a film consisting of a polyester film such as polyethylene terephthalate, polyethylene naphthalate, polyethylene isophthalate, and polybutylene terephthalate, a (meth)acrylic resin, a polycarbonate resin, a polystyrene type resin, a polyolefin resin, a cyclic polyolefin resin, and a cellulose resin such as cellulose acylate. Here, the (meth)acrylic resin is preferably a polymer having a lactone ring structure, a polymer having a glutaric anhydride ring structure, and a polymer having a glutarimide ring structure.

Other plastic films can be used as long as the plastic films have required strength and optical suitability. The support may be an unstretched film or may be uniaxially or biaxially stretched. Otherwise, the temporary support may be a plastic film in which an angle of the axis method formed according to the stretching ratio and stretching crystallization is controlled.

As the support, those having ultraviolet permeability are preferable. It is preferable to have ultraviolet permeability in view of manufacturing suitability, since in the step (4), ultraviolet irradiation from the coating layer side can be performed in a case of curing the layer (a).

Specifically, the maximum transmittance of the support at the wavelength of 250 nm to 300 nm is preferably 20% or more, more preferably 40% or more, and most preferably 60% or more. It is preferable that the maximum transmittance at the wavelength of 250 nm to 300 nm is 20% or more, since the layer (a) can be easily cured by being irradiated with ultraviolet rays from the coating layer side.

Specifically, the maximum transmittance of the pressure sensitive film in which the layer (b) is formed on the support at the wavelength of 250 nm to 300 nm is preferably 20% or more, more preferably 40% or more, and most preferably 60% or more.

The film thickness of the support is not particularly limited, but is preferably 10 μm to 100 μm, more preferably 10 μm to 50 μm, and even more preferably 10 μm to 40 μm.

As the pressure sensitive film obtained by forming the layer (b) on the support, a commercially available protective film can be suitably used. Specific examples thereof include AS3-304, AS3-305, AS3-306, AS3-307, AS3-310, AS3-0421, AS3-0520, AS3-0620, LBO-307, NBO-0424, ZBO-0421, S-362, and TFB-4T3-367AS manufactured by Fujimori Kogyo Co., Ltd.

According to the present invention, the layer (a) is cured while a state in which the particle (a2) is buried in the layer obtained by combining the layer (a) and the layer (b) is maintained in the step (4), in the stage before the step (4), it is preferable to have an uneven shape formed by the particle (a2) protruding from the interface of the layer (a). In this manner, in a case where the layer (b) is peeled off in the step (5) after the layer (a) is cured in the step (4), it is possible to obtain the antireflection film in a state in which the particle (a2) protrudes on the surface of the layer (a).

In the stage before the step (4), in order to provide an uneven shape formed by the particle (a2) protruding from the interface of the layer (a), in the step (3) described below, it is preferable to cause a portion of the curable compound (a1) to permeate a substrate (in a case where the substrate has a functional layer such as a hard coat layer, a functional layer).

According to the present invention, it is possible to include a step (1-2) of curing a portion of the curable compound (a1) in the layer (a) between the steps (1) and (2) to obtain the cured compound (a1c).

In a case where a portion of the curable compound (a1) is cured in the step (1-2), the particle (a2) is caused to hardly move such that the aggregation of the particle (a2) can be suppressed.

The expression “a portion of the curable compound (a1) is cured” means that not all of the curable compound (a1) is not cured, but only a portion thereof is cured. By curing a portion of the curable compound (a1) in a step (1-2), it is possible to form a satisfactory uneven shape (moth eye structure) in a case where the position of the interface between the layer (a) and the layer (b) is caused to descend to the substrate side such that the particle (a2) protrudes from the interface of the layer (a) on an opposite side of the interface of the layer (a) on the substrate side in the step (3).

[Step (3)]

The step (3) is a step of descending the position of the interface between the layer (a) and the layer (b) such that the particle (a2) is buried in the layer obtained by combining the layer (a) and the layer (b) and protrudes from the interface of the layer (a) on an opposite side of the interface of the layer (a) on the substrate side.

According to the present invention, the expression “the particle (a2) is buried in the layer obtained by combining the layer (a) and the layer (b)” indicates that the thickness of the layer obtained by combining the layer (a) and the layer (b) is 0.8 times or more of the average primary particle diameter of the particles (a2).

It is preferable that the step (3) is performed by causing a portion of the curable compound (a1) to permeate the substrate (which may be a functional layer, in a case where the substrate has a functional layer) or causing a portion of the curable compound (a1) to permeate the pressure sensitive adhesive layer.

In the step (3), in a case where a portion of the curable compound (a1) is caused to permeate the substrate (may be the functional layer, in a case where the substrate has the functional layer), it is preferable to heat a laminate having the substrate, the layer (a), and the layer (b). By the heating, it is possible to cause a portion of the curable compound (a1) to effectively permeate the substrate. The temperature in heating is preferably smaller than the glass transition temperature of the substrate. Specifically, the temperature is preferably 60° C. to 180° C. and more preferably 80° C. to 130° C.

In step (3), in a case where a portion of the curable compound (a1) is caused to permeate the pressure sensitive adhesive layer, the laminate having the substrate, the layer (a), and the layer (b) is maintained preferably at less than 60° C. and more preferably at 40° C. or less. By maintaining the temperature at 40° C. or less, the viscosity of the curable compound (a1) and pressure sensitive adhesive can be maintained to be high, and at the same time, the thermal motion of the particles can be suppressed, and thus has a high effect of suppressing the decrease of the antireflection performances due to aggregation of the particles and the increase of the haze or the muddiness. The lower limit of the temperature at which the laminate having the substrate, the layer (a), and the layer (b) is maintained is not particularly limited, and may be the room temperature or a temperature lower than the room temperature.

[Step (4)]

The step (4) is a step of curing the layer (a) in a state in which the particle (a2) is buried in the layer obtained by combining the layer (a) and the layer (b).

According to the present invention, the expression “a state in which the particle (a2) is buried in the layer obtained by combining the layer (a) and the layer (b)” indicates that the thickness of the layer obtained by combining the layer (a) and the layer (b) is 0.8 times or more of the average primary particle diameter of the particles (a2).

The expression “curing the layer (a)” means polymerizing the curable compound (a1) included in the layer (a), and a binder resin in the completed antireflection layer of the antireflection film can be formed. In Step (4), since a state in which the particle (a2) is buried in the layer obtained by combining the layer (a) and the layer (b) is maintained, the aggregation of the particle (a2) is suppressed and the moth eye structure can be formed.

In a case where it is considered that the state in which the particle (a2) is buried in the layer obtained by combining the layer (a) and the layer (b) cannot be maintained due to the volatilization of the component of the layer (b) or the layer (a) after the layer (b) is provided or the permeation of the component to the substrate (the functional layer in a case where the substrate has the functional layer), an operation of thickening the layer (b) in advance or the like can be performed.

As a mechanism of suppressing particle aggregation by maintaining a state in which the particle (a2) is buried in the layer obtained by combining the layer (a) and the layer (b), it is assumed that, it is known that a large attractive force derived from the surface tension called lateral capillary force works in a case where the particle (a2) is exposed to the air interface until the layer (a) is cured, and thus by burying the particle (a2) in the layer obtained by combining the layer (a) and the layer (b), the attractive force can be reduced.

The curing can be performed by irradiation with ionizing radiation. The kind of ionizing radiation is not particularly limited, and examples thereof include X-rays, electron beams, ultraviolet rays, visible light, and infrared rays. However, ultraviolet light is widely used. For example, in a case where the coating film is ultraviolet curable, it is preferable that the curable compound (a1) of the layer (a) is cured by being irradiated with ultraviolet rays in an irradiation amount of 10 mJ/cm² to 1,000 mJ/cm² by an ultraviolet lamp. The irradiation amount is more preferably 50 mJ/cm² to 1,000 mJ/cm² and still more preferably 100 mJ/cm² to 500 mJ/cm². At the time of irradiation, the energy may be applied at once or can be applied in a divided manner. As the ultraviolet lamp type, a metal halide lamp, a high pressure mercury lamp, or the like is suitably used.

The oxygen concentration at the curing is preferably 0 to 1.0 vol %, more preferably 0 to 0.1 vol %, and most preferably 0 to 0.05 vol %. In a case where the oxygen concentration at curing is smaller than 1.0 vol %, curing inhibition caused by oxygen is hardly received, and the film becomes strong.

In the steps (2) to (4), it is preferable that a plurality of particles (a2) are not present in a direction orthogonal to the surface of the substrate.

In steps (2) to (4), the total film thickness of the film thickness of the layer (a) and the film thickness of the layer (b) is preferably more than the average primary particle diameter of the particle (a2).

It is preferable that the total film thickness of the film thickness of the layer (a) and the film thickness of the layer (b) is more than the average primary particle diameter of the particle (a2), since it is possible to cause the particle (a2) to be buried in the layer combining the layer (a) and the layer (b).

However, since it is possible to obtain a state (moth eye structure) in which the particle (a2) protrudes from the surface of the layer (a) in a case where the pressure sensitive film including the layer (b) in the step (5) described below is peeled off in the step (4), it is preferable that the film thickness of the layer (a) is smaller than the average primary particle diameter of the particle (a2), and it is more preferable that the film thickness thereof is equal to or less than a half of the average primary particle diameter of the particles (a2).

It is preferable that the film thickness of the layer (a) in the step (4) is adjusted such that the height of the interface of the layer (ca) on an opposite side of the interface of the layer (ca) on the substrate side, which is obtained by curing this becomes equal to or less than a half of the average primary particle diameter of the particle (a2) (in this case, the film thickness of the layer (ca) is preferably adjusted to be equal to or less than a half of the average primary particle diameter of the particle (a2)), and it is more preferable that the film thickness thereof is adjusted such that, in a case where the film cross section of the layer (ca) is observed by a scanning electron microscope (SEM) and the film thicknesses at 100 random points are measured to obtain the average value, the average value becomes 10 nm to 100 nm (more preferably 20 nm to 90 nm and even more preferably 30 nm to 70 nm).

With respect to the layer (a), in a case where the surface free energy (ca) of the surface of the layer (ca) formed by curing this is measured by the following method, the surface free energy (ca) is preferably 40 mN/m or less, more preferably 5 mN/m to 35 mN/m, and most preferably 10 mN/m to 26 mN/m.

Since in a case where the surface free energy (b) of the surface of the layer (b) is close to the surface free energy (ca) of the surface of the cured layer (a), the attractive force working between the particles (a2) can be reduced, in view of suppressing the aggregation of the particle (a2), the surface free energy (b) is preferably 40 mN/m or less, more preferably 5 mN/m to 35 mN/m, and most preferably 10 mN/m to 26 mN/m.

The value obtained by subtracting the surface free energy (b) of the surface of the layer (b) from the surface free energy (ca) of the surface of the cured layer (a) is −15 mN/m to 10 mN/m or less, preferably −7 mN/m to 5 mN/m, and even more preferably −5 mN/m to 0 mN/m. In a case where the value obtained by subtracting the surface free energy (b) of the surface of the layer (b) from the surface free energy (ca) of the surface of the cured layer (a) is −15 mN/m to 10 mN/m, the attractive force working between the particles (a2) can be reduced, and thus the aggregation of the particle (a2) can be further suppressed.

(Method of Measuring Surface Free Energy (Ca) of Surface of Cured Layer (a))

After the layer (a) is provided in the same condition as in the step (1), without providing the layer (b) (by not bonding pressure sensitive film) and without causing the particle (a2) to protrude from the interface on the opposite side of the interface of the layer (a) on the substrate side, while nitrogen purge is performed so as to have an atmosphere of the oxygen concentration of 0.01 vol % or less, irradiation is performed with ultraviolet rays in an illuminance of 200 mW/cm² and in an irradiation amount of 300 mJ/cm² by using an air cooling metal halide lamp (manufactured by Eye Graphics Co., Ltd.) of 160 W/cm, so as to cure the layer (a).

Subsequently, by using a contact angle meter [“CA-X” type contact angle meter, manufactured by Kyowa Interface Science Co., Ltd.], in a dry state (temperature: 25° C. and relative humidity: 65%), using pure water as a liquid, a liquid droplet having a diameter of 1.0 mm is formed at the tip of the needle, and the liquid droplet is brought into contact with the surface of the cured layer (a), so as to form a droplet on the layer (a). A degree of an angle which is an angle formed by the tangent with respect to the liquid surface and the surface of the layer (a) and an angle on the side including the liquid is measured at a point in which the layer (a) is in contact with the liquid, so as to obtain a contact angle of water. The contact angle is measured using methylene iodide instead of pure water as a liquid, and the surface free energy was obtained from the following formula.

That is, with reference to D. K. Owens: J. Appl. Polym. Sci., 13, 1741 (1969), the surface free energy (γs^{v}: unit, mN/m) is defined by a value γs^{v} (=γs^{d}+γs^{h}) represented by the sum of γs^{d} and γs^{h} obtained from the following simultaneous equations a and b from contact angles θ_{H2O}, θ_{CH2I2} respectively of pure water H₂O experimentally obtained on the film and methylene iodide CH₂I₂.

1+cos θ_{H2O}=2√γs^{d}(√γ_{H2O}^{d}/γ_{H2O}^{v})+2√γs^{h}(√γ_{H2O}^{h}/γ_{H2O}^{v}) a.

1+cos θ_{CH2I2}=2√γs^{d}(√γ_{CH2I2}^{d}/γ_{CH2I2}^{v})+2√γs^{h}(√γ_{CH2I2}^{h}/γ_{CH2I2}^{v}) b.

γ_{H2O}^{d}=21.8, γ_{H2O}^{h}=51.0, γ_{H2O}^{v}=72.8

γ_{CH2I2}^{d}=49.5, γ_{CH2I2}^{h}=1.3, γ_{CH2I2}^{v}=50.8

(Method of Measuring Surface Free Energy of the Layer (b))

The layer (b) is formed on the support, and the surface free energy of the surface of the layer (b) is calculated from the contact angles of pure water and methylene iodide in the same manner as the method for measuring the surface free energy (ca) of the surface of the layer (a).

In view of causing dirt such as fingerprints to not adhere or to be easily wiped off even in a case of adhering, the contact angle of water on the surface of the cured layer (a) in which the moth eye structure caused by the particle (a2) is formed is preferably 500 or more, more preferably 70° or more, and even more preferably 90° or more. In a case where the surface of the layer (a) is a hydrophobic surface (that is, in a case where the layer (a) is formed so that the surface free energy (ca) obtained by the measuring method described above becomes lower), by forming a moth eye structure, extremely high hydrophobicity can be obtained due to the surface area increasing effect. The contact angle can be measured by the same method in a case where the surface free energy of the layer (a) is calculated.

[Method of Manufacturing Antireflection Film]

The method of manufacturing of the antireflection film of the present invention has the step (5) of peeling off the pressure sensitive film of the laminate obtained by the method of manufacturing the laminate of the present invention.

In the laminate of the present invention, the pressure sensitive adhesive hardly remains on the layer (a) side even in a case where the layer (b) is peeled off, and the substrate and the cured layer (a) are not dissolved but may be washed by using a solvent that dissolves the pressure sensitive adhesive.

After the pressure sensitive film including the layer (b) is peeled off in the step (5), it is possible to obtain an antireflection film having a moth eye structure consisting of an uneven shape formed of the particle (a2) on the surface of the layer (a).

[Laminate]

The laminate of the present invention is

a laminate having a substrate, the layer (ca) including a resin, the particle (a2) having an average primary particle diameter of 100 nm to 380 nm, and the layer (b) including the pressure sensitive adhesive having a gel fraction of 95.0% or more, the layer (ca) is present on a side closer to the substrate than the layer (b),

the particle (a2) is buried in the layer obtained by combining the layer (ca) and the layer (b) and protrudes from the interface on the opposite side of the interface of the layer (ca) on the substrate side, and

the value obtained by subtracting the surface free energy (b) of the surface of the layer (b) from the surface free energy (ca) of the surface of the layer (ca) is −15 mN/m to 10 mN/m.

The layer (ca) including the resin corresponds to the cured layer (a) of the step (4) by the method of manufacturing the laminate of the present invention.

It is preferable that the laminate of the present invention further has a support on the interface side on the opposite side of the interface of the layer (b) on the layer (ca) side.

In the laminate of the present invention, it is preferable that the height of the interface on the opposite side of the interface of the layer (ca) on the substrate side is equal to or less than a half of the average primary particle diameter of the particles (a2).

In addition, descriptions, specific examples, and preferable ranges of respective layers and respective components in the laminate of the present invention are the same as those described in the method of manufacturing the laminate of the present invention.

[Antireflection Film]

An example of a preferable embodiment of an antireflection film obtained by the manufacturing method of the present invention is illustrated in FIG. 2.

An antireflection film 10 in FIG. 2 has a substrate 1 and an antireflection layer 2. The antireflection layer 2 includes the particle (a2) (reference numeral 3) and a binder resin film (reference numeral 4) which is a cured layer (a) (layer (ca)). The particle 3 protrudes from the binder resin film 4 to form a moth eye structure.

(Moth Eye Structure)

The moth eye structure refers to a surface obtained by processing of a substance (material) for suppressing reflection of light and a structure of having a periodic microstructure pattern. Particularly, in a case of having the purpose of suppressing reflection of visible light, the moth eye structure refers to a structure having a microstructure pattern with a period of less than 780 nm. It is preferable that the period of the microstructure pattern is less than 380 nm, the color of reflected light becomes small. It is preferable that the periodicity of the uneven shape of the moth eye structure is 100 nm or more, light having a wavelength of 380 nm can recognize a microstructure pattern and is excellent in antireflection properties. Whether the moth eye structure is present can be checked by observing the surface shape with a scanning electron microscope (scanning electron microscope (SEM)), an atomic force microscope (AFM) or the like, and checking whether the microstructure pattern can be formed.

In the uneven Shape the antireflection layer of the antireflection film manufactured by the manufacturing method of the present invention, it is preferable that B/A which is the ratio of a distance A between the peaks of the adjacent protrusions and a distance B between the center between the peaks of the adjacent protrusions and the recessed part is 0.4 or more. In a case where B/A is 0.4 or more, the refractive index gradient layer in which the depth of the recessed part is greater than the distance between the protrusions and the refractive index gradually changes from the air to the inside of the antireflection layer can be formed, and thus the reflectance can be further reduced.

B/A is more preferably 0.5 or more. In a case where B/A is 0.5 or more, the distance A between the peaks of the adjacent protrusions (protrusions formed by the particles) becomes the particle diameter or more, such that the recessed part is formed between particles. As a result, it is assumed that, in a case where both of the interface reflection due to a region having a sharp change on the refractive index depending on the curvature of the upper side of the protrusion and the interface reflection due to a region having a sharp change on the refractive index depending on the curvature of the recessed part between the particles are present, in addition to the refractive index gradient layer effect by the moth eye structure, the reflectance is more effectively reduced.

B/A can be controlled by the volume ratio of the binder resin and the particle in the antireflection layer after curing. Therefore, it is important to appropriately design the formulation ratio of the binder resin and the particle. In a case where the binder resin permeates the substrate in the step of preparing the moth eye structure or volatilizes, the volume ratio of the binder resin and the particle in the antireflection layer becomes different from the formulation ratio in the composition for forming the antireflection layer, and thus the matching with the substrate is appropriately set.

In order to realize the low reflectance and suppress the occurrence of haze, it is preferable that the particle for forming the protrusions is uniformly spread at an appropriate filling rate. In view of the above, the content of the inorganic particle for forming the protrusions is preferably adjusted such that the inorganic particle is uniform over the entire antireflection layer. The filling rate can be measured as the area occupation ratio (particle occupancy ratio) of the inorganic particle located most surface side in a case of observing the inorganic particle for forming the protrusions from the surface by scanning electron microscope (SEM) or the like, and is 25% to 64%, preferably 25% to 50%, and more preferably 30% to 45%.

The uniformity of the surface of the antireflection film can be evaluated by haze. With respect to the measurement, a film sample of 40 mm×80 mm can be measured according to JIS-K 7136 (2000) with a haze meter NDH 4000 manufactured by Nippon Denshoku Industries Co., Ltd. at 25° C. and a relative humidity of 60%. In a case where a particle aggregated and was not homogeneous, the haze was high. It is preferable that the haze was lower. The value of the haze is preferably 0.0% to 3.0%, more preferably 0.0% to 2.5%, and even more preferably 0.0% to 2.0%.

[Hard Coat Layer]

According to the present invention, a hard coat layer can further be provided between the substrate and the layer (a). In the case where the hard coat layer is provided on the substrate, as described above, according to the present invention, the hard coat layer on the substrate is collectively referred to as the substrate in some cases.

The hard coat layer is preferably formed by a crosslinking reaction or a polymerization reaction of a curable compound (preferably an ionizing radiation curable compound) which is a compound having a polymerizable group. For example, the hard coat layer can be formed by coating the substrate with a coating composition including an ionizing radiation curable polyfunctional monomer or a polyfunctional oligomer and subjecting the polyfunctional monomer or the polyfunctional oligomer to crosslinking reaction or polymerization reaction.

As the functional group (polymerizable group) of the ionizing radiation curable polyfunctional monomer or polyfunctional oligomer, those having light, electron beams, or radiation polymerizability are preferable. Among them, a photopolymerizable functional group is preferable.

Examples of the photopolymerizable functional group include unsaturated polymerizable functional groups such as a (meth)acryloyl group, a vinyl group, a styryl group, and an allyl group. Among them, a (meth)acryloyl group is preferable.

Specifically, a compound which is the same as the curable compound (a1) described above can be used.

In view of applying sufficient durability and impact resistance in a film, thickness of the hard coat layer is usually about 0.6 μm to 50 μm and preferably 4 μm to 20 μm.

The strength of the hard coat layer is preferably H or more and more preferably 2H or more in a pencil hardness test. Further, in the Taber test according to JIS K5400, it is more preferable in a case where an abrasion amount of a test piece before and after the test is smaller.

The hard coat layer according to the present invention may include cellulose acylate in an area within 1 μm in the film thickness direction from the interface with the antireflection layer.

As the cellulose acylate, substrates and the like disclosed in [0072] to [0084] of JP2012-093723A can be preferably used.

The hard coat layer including cellulose acylate in an area within 1 μm from the interface with the antireflection layer in the film thickness direction can be formed, for example, by coating a substrate (a cellulose acylate film or the like) including cellulose acylate with a composition for forming a hard coat layer having permeability to the substrate and containing a solvent and a curable compound, causing the curable compound to permeate the substrate, and curing the composition. The hard coat layer can also be formed by mixing and curing cellulose acylate and the curable compound.

In a case where the antireflection film is cut with a microtome and the cross section was analyzed with a time-of-flight secondary ion mass spectrometer (TOF-SIMS), the hard coat layer can be measured as a portion a cured product of cellulose acylate and the ionizing radiation curable compound is detected, and the film thickness of this area can also be measured from the cross-sectional information of the TOF-SIMS in the in the same manner.

The hard coat layer can be measured, for example, by detecting another layer between the substrate and the antireflection layer by observing the cross section by a reflection spectroscopic film thickness meter or a transmission electron microscope (TEM) by using light interference. As the reflective spectroscopic film thickness meter, FE-3000 (manufactured by Otsuka Electronics Co., Ltd.) or the like can be used.

According to the present invention, a method of previously half-curing the hard coat layer such that the curable compound (a1) permeates the hard coat layer in the step (3) in a case where the layer (a) is laminated on the hard coat layer and full-curing the hard coat layer after the curable compound (a1) permeates is preferable.

For example, in a case where the coating film is ultraviolet-curable, the hard coat layer can be half-cured by appropriately adjusting the oxygen concentration in a case of curing and the ultraviolet irradiation amount. It is preferable that the coating film is cured by being irradiated with ultraviolet rays in an irradiation amount of 1 mJ/cm² to 300 mJ/cm² by an ultraviolet lamp. The irradiation amount is more preferably 5 mJ/cm² to 100 mJ/cm² and still more preferably 10 mJ/cm² to 70 mJ/cm². At the time of irradiation, the energy may be applied at once or can be applied in a divided manner. As the ultraviolet lamp type, a metal halide lamp, a high pressure mercury lamp, or the like is suitably used.

The oxygen concentration at the curing is preferably 0.05 to 5.0 vol %, more preferably 0.1 to 2 vol %, and most preferably 0.1 to 1 vol %.

(Solvent Having Permeability to Cellulose Acylate)

The composition for forming the hard coat layer preferably contains a solvent (also referred to as “permeable solvent”) having permeability to cellulose acylate.

The solvent having permeability with respect to cellulose acylate is a solvent having solubility to a substrate (cellulose acylate substrate) containing cellulose acylate.

Here, the solvent having solubility to a cellulose acylate substrate means a solvent in which, after the cellulose acylate substrate having a size of 24 mm×36 mm (thickness: 80 μm) is immersed in a 15 ml bottle including the above solvent at room temperature (25° C.) for 60 seconds and then taken out, in a case where the immersed solution is subjected to gel permeation chromatography (GPC), the peak surface area of cellulose acylate is 400 mV/sec or more. Otherwise, the solvent means a solvent of which the shape thereof is lost by causing a cellulose acylate substrate having a size of 24 mm×36 mm (thickness 80 μm) to stand in a 15 ml bottle including the above solvent at room temperature (25° C.) for 24 hours and appropriately shaking the bottle or the like such that the cellulose acylate substrate is completely dissolved and which has solubility to the cellulose acylate substrate.

As the permeable solvent, methyl ethyl ketone (MEK), dimethyl carbonate, methyl acetate, acetone, methylene chloride, and the like can be preferably used, but the present invention is not limited thereto. Methyl ethyl ketone (MEK), dimethyl carbonate, and methyl acetate are more preferable.

The composition for forming a hard coat layer may include a solvent in addition to the permeable solvent (for example, ethanol, methanol, 1-butanol, isopropanol (IPA), methyl isobutyl ketone (MIBK), and toluene).

In the composition for forming a hard coat layer, the content of the permeable solvent is preferably 50 mass % to 100 mass % and more preferably 70 mass % to 100 mass % with respect to the total mass of the solvent included in the composition for forming a hard coat layer.

The solid content concentration of the composition for forming a hard coat layer is preferably 20 mass % to 70 mass % and more preferably 30 mass % to 60 mass %.

(Other Components)

In addition to the above components, a polymerization initiator, an antistatic agent, an antistatic agent and the like can be appropriately added to the composition for forming a hard coat layer. Various additives such as reactive or non-reactive leveling agents and various sensitizing agents may be mixed.

(Polymerization Initiator)

If necessary, radicals and cationic polymerization initiators and the like may be suitably selected to be used. These polymerization initiators are decomposed by light irradiation and/or heating to generate radicals or cations and promote radical polymerization and cationic polymerization.

(Antistatic Agent)

As specific examples of the antistatic agent, antistatic agents well known in the related art such as quaternary ammonium salt, a conductive polymer, and a conductive fine particle can be used, though the antistatic agents are particularly limited. However, in view of the low cost and the ease of handling, an antistatic agent having quaternary ammonium salt is preferable.

(Refractive Index Adjusting Agent)

For the purpose of controlling the refractive index of the hard coat layer, a high refractive index monomer or an inorganic particle can be added as a refractive index adjusting agent. In addition to the effect of controlling the refractive index, the inorganic particles also have an effect of suppressing curing shrinkage due to the crosslinking reaction. According to the present invention, after the hard coat layer is formed, a polymer generated by polymerizing the polyfunctional monomer and/or the high refractive index monomer or the like and inorganic particles dispersed therein are collectively referred to as a binder.

(Leveling Agent)

As specific examples of the leveling agent, leveling agents well-known in the related art such as fluorine-based or silicone-based leveling agents can be used. The composition for forming a hard coat layer to which the leveling agent is added can provide coating stability to the surface of the coating film in a case of coating or drying.

The antireflection film manufactured by the manufacturing method of the present invention can be appropriately used as a polarizing plate protective film.

The polarizing plate protective film using the antireflection film manufactured by the manufacturing method of the present invention can be bonded to a polarizer to form a polarizing plate and can be appropriately used in a liquid crystal display device or the like.

[Polarizing Plate]

The polarizing plate is a polarizing plate having a polarizer and at least one of the protective films for protecting the polarizer, and it is preferable that at least one of the protective films is an antireflection film manufactured by the method for manufacturing the antireflection film of the present invention.

The polarizer includes an iodine-containing polarizer, a dye-based polarizer using a dichroic dye, and a polyene-based polarizer. The iodine-based polarizer and the dye-based polarizer can be generally manufactured by using a polyvinyl alcohol-based film.

[Cover Glass]

The antireflection film manufactured by the method for manufacturing an antireflection film of the present invention can also be applied to a cover glass.

[Image Display Device]

The antireflection film manufactured by the method for manufacturing an antireflection film of the present invention can also be applied to an image display device.

Examples of the image display device include a display device using a cathode ray tube (CRT), a plasma display panel (PDP), an electroluminescent display (ELD), a vacuum fluorescent display (VFD), a field emission display (FED), and a liquid crystal display device (LCD), and a liquid crystal display device is particularly preferable.

Generally, a liquid crystal display device has a liquid crystal cell and two polarizing plates disposed on both sides of the liquid crystal cell, and the liquid crystal cell carries a liquid crystal between the two electrode substrates. One optically anisotropic layer may be arranged between the liquid crystal cell and one polarizing plate, or two optically anisotropic layers may be arranged between the liquid crystal cell and both polarizing plates. As the liquid crystal cell, liquid crystal cells of various driving methods such as a Twisted Nematic (TN) mode, a Vertically Aligned (VA) mode, an Optically Compensatory Bend (OCB) mode, and an In-Plane Switching (IPS) mode can be applied.

### EXAMPLES

Hereinafter, the present invention is specifically described with reference to the examples. A material, a reagent, a substance quantity, a ratio thereof, an operation, and the like provided in the following examples can be suitably changed without departing from the gist of the present invention. Accordingly, the scope of the present invention is not limited to the following specific examples.

### Example 1

(Preparation of Composition for Forming Hard Coat Layer)

Each component was added in the following composition, and the obtained composition was introduced to a mixing tank, stirred, and filtrated with a polypropylene filter having a pore size 0.4 μm so as to obtain a hard coat layer coating liquid HC-1.

(Hard Coat Layer Coating Liquid HC-1)

| | | |
|---|---|---|
| A-TMMT | 33.6 | parts by mass |
| IRGACURE 127 | 1.4 | parts by mass |
| Methyl ethyl ketone (MEK) | 35.8 | parts by mass |
| Methyl acetate | 29.2 | parts by mass |

A-TMMT: Pentaerythritol tetraacrylate (manufactured by Shin Nakamura Chemical Co., Ltd.)
IRGACURE 127: Photopolymerization initiator (manufactured by BASF Japan Ltd.) [Synthesis of silica particle P1]

67.54 kg of methyl alcohol and 26.33 kg of 28 mass % aqueous ammonia (water and catalyst) were introduced to a reactor with capacity of 200 L which is equipped with a stirrer, a dropwise adding device, and a thermometer, and the liquid temperature was adjusted to 33° C. while stirring. On the other hand, a solution prepared by dissolving 12.70 kg of tetramethoxysilane in 5.59 kg of methyl alcohol was introduced to the dropwise adding device. While the liquid temperature in the reactor was maintained to 33° C., the above solution was added dropwise from the dropwise adding device over 44 minutes. After the dropwise addition was completed, stirring was continued while the liquid temperature was maintained to the above temperature for 44 minutes, and hydrolysis and condensation of tetramethoxy silane were performed, so as to obtain a dispersion liquid containing a silica particle precursor. This dispersion liquid was air-dried under the conditions of a heating tube temperature of 175° C. and a reduced pressure degree of 200 torr (27 kPa) by using an instantaneous vacuum evaporator (CRUX SYSTEM CVX-8B model manufactured by Hosokawa Micron Corporation), so as to obtain a silica particle P1.

The average primary particle diameter of the silica particle P1 was 180 nm, the dispersion degree (CV value) of the particle diameter was 3.3%, and the indentation hardness was 340 MPa.

[Preparation of Calcined Silica Particle P2]

5 kg of the silica particle P1 were introduced to a crucible, calcined at 900° C. for two hours in an electric furnace, cooled, and then pulverized by using a pulverizer, to obtain the calcined silica particle before classification. Disintegration and classification were performed by using a jet pulverizing classifier (IDS-2 model manufactured by Nippon Pneumatic Mfg., Co., Ltd.) to obtain a calcined silica particle P2.

[Preparation of Silane Coupling Agent-Treated Silica Particle P3]

5 kg of the calcined silica particle P2 was introduced to a Henschel mixer (FM20J model manufactured by Nippon Coke & Engineering Co., Ltd.) having a capacity of 20 L equipped with a heating jacket. A solution obtained by dissolving 45 g of 3-acryloxypropyltrimethoxysilane (KBM 5103 manufactured by Shin-Etsu Chemical Co., Ltd.) in 90 g of methyl alcohol was added dropwise to a portion in which the calcined silica particle P2 was stirred and mixed. Thereafter, the temperature was raised to 150° C. over about one hour while mixing and stirring, and the mixture was maintained at 150° C. for 12 hours, and the heat treatment was performed. Thereafter, in the heat treatment, the attachment on the wall was scraped off while the scraping device was rotated constantly in the opposite direction to the stirring blade. If necessary, the deposits on the wall were scraped off with a spatula. After heating, cooling was performed, and disintegration and classification were performed by using a jet pulverizing classifier, so as to obtain a silane coupling agent treated silica particle P3.

The average primary particle diameter of the silane coupling agent treated silica particle P3 was 181 nm, the dispersion degree (CV value) of the particle diameter was 3.3%, and the indentation hardness was 470 MPa.

[Preparation of Silica Particle Dispersion Liquid PA-1]

50 g of the silica particle P3 treated with a silane coupling agent, 200 g of MEK, and 600 g of zirconia beads having a diameter of 0.05 mm were introduced in a 1 L bottle having a diameter of 12 cm, set in a ball mill V-2M (IRIE SHOKAI Co., Ltd.), and dispersed for 10 hours at 250 rotation/min. In this manner, a silica particle dispersion PA-1 (concentration of solid content: 20 mass %) was prepared.

[Synthesis of Compound C3]

19.3 g of 3-isocyanatepropyltrimethoxysilane, 3.9 g of glycerin 1,3-bisacrylate, 6.8 g of 2-hydroxyethyl acrylate, 0.1 g of dibutyltin dilaurate, and 70.0 g of toluene were added to a flask equipped with a reflux condenser and a thermometer and were stirred at room temperature for 12 hours. After stirring, 500 ppm of methylhydroquinone was added, and distillation under reduced pressure was performed, so as to obtain compound C3.

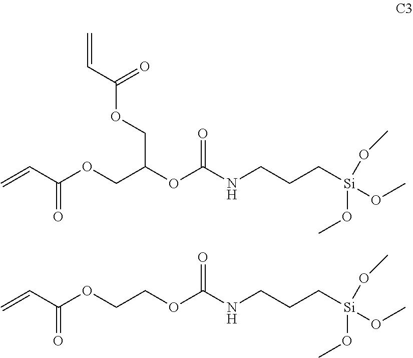

[Preparation of Composition for Forming Layer (a)]

Each component was introduced to a mixing tank so as to have the composition, was stirred for 60 minutes, and was dispersed by an ultrasonic disperser for 30 minutes to obtain a coating liquid.

Composition (A-1)

| | | |
|---|---|---|
| U-15HA | 1.0 | part by mass |
| Compound C3 | 8.7 | parts by mass |
| IRGACURE 127 | 0.4 | parts by mass |
| Compound P | 0.1 | parts by mass |
| Silica particle dispersion liquid PA-1 | 25.4 | parts by mass |
| Compound A | 0.17 | parts by mass |
| Ethanol | 15.0 | parts by mass |
| Methyl ethyl ketone | 34.4 | parts by mass |
| Acetone | 15.0 | parts by mass |

Composition (A-2)

| | | |
|---|---|---|
| U-15HA | 1.0 | part by mass |
| Compound C3 | 8.7 | parts by mass |
| IRGACURE127 | 0.4 | parts by mass |
| Compound P | 0.1 | parts by mass |
| Silica particle dispersion liquid PA-1 | 25.4 | parts by mass |
| Compound A | 0.03 | parts by mass |
| Ethanol | 15.0 | parts by mass |
| Methyl ethyl ketone | 34.4 | parts by mass |
| Acetone | 15.0 | parts by mass |

Composition (A-3)

| | | |
|---|---|---|
| U-15HA | 1.0 | part by mass |
| Compound C3 | 8.7 | parts by mass |
| IRGACURE127 | 0.4 | parts by mass |
| Compound P | 0.1 | parts by mass |
| Silica particle dispersion liquid PA-1 | 25.4 | parts by mass |
| Compound A | 0.10 | parts by mass |
| Ethanol | 15.0 | parts by mass |
| Methyl ethyl ketone | 34.4 | parts by mass |
| Acetone | 15.0 | parts by mass |

U-15HA and the compound C₃ were the curable compound (a1).

The compounds used are provided below.

U-15HA (manufactured by Shin Nakamura Chemical Co., Ltd.): Urethane acrylate

IRGACURE 127: Photopolymerization initiator (manufactured by BASF Japan Ltd.)

Compound P: 2-(4-Methoxyphenyl)-4,6-bis(trichloromethyl)-1,3,5-triazine (photoacid generator, manufactured by Tokyo Chemical Industry Co., Ltd.)

Compound A: F-784-F (manufactured by DIC Corporation)

<Preparation of Antireflection Film 1>

(Forming of Hard Coat Layer)

The substrate (ZRT60, manufactured by Fujifilm Corporation) was coated with the hard coat layer coating liquid HC-1 by using a die coater. After drying was performed at 30° C. for 90 seconds and then at 60° C. for one minute, while nitrogen purging is performed so as to have an atmosphere of an oxygen concentration of approximately 0.3 vol %, irradiation is performed with ultraviolet rays in an illuminance of 200 mW/cm² and in an irradiation amount of 60 mJ/cm² by using an air cooling metal halide lamp (manufactured by Eye Graphics Co., Ltd.) of 160 W/cm so as to cure a coating layer, such that a hard coat layer having a thickness of 8 μm is formed. The substrate with a hard coat layer is set as HC-1.

(Step (1): Coating of Layer (a))

A hard coat layer of the substrate HC-1 with a hard coat layer was coated with the composition (A-1) by using a die coater at 2.8 ml/m², and was dried for 90 seconds at 30° C. The film thickness of the layer (a) in the step (1) was as provided in Table 1 below.

(Step (2): Bonding of Pressure Sensitive Film)

Subsequently, the pressure sensitive layer obtained by peeling off a release film from a protective film (MASTAC TFB AS3-304) manufactured by Fujimori Kogyo Co., Ltd. was bonded to the dried layer (a) such that the pressure sensitive adhesive layer (layer (b)) on the layer (a) side. The bonding was performed at a speed of 1 by using a commercial laminator Bio330 (manufactured by DAE-EL Co.)

The protective film herein refers to a laminate formed of the support/the pressure sensitive adhesive layer/the release film, and a laminate obtained by peeling off the release film from the protective film and formed of the support/the pressure sensitive adhesive layer was a pressure sensitive film.

The protective film used is as below.
MASTACK TFB AS3-304 (manufactured by Fujimori Kogyo Co., Ltd., Optical protective film with antistatic function) (hereinafter also referred to as “AS3-304”)

Support: Polyester film (thickness: 38 μm)

Thickness of pressure sensitive adhesive layer: 20 μm

Maximum transmittance at wavelength of 250 nm to 300 nm in state in which release film was peeled: Less than 0.1%

The transmittance was measured using a ultraviolet-visible-near infrared spectrophotometer UV3150 manufactured by Shimadzu Corporation.

(Step (3): Permeation of Curable Compound (a1) into Hard Coat Layer)

While the pressure sensitive film was bonded, heating was performed at 120° C. for 15 minutes such that a portion of the curable compound (a1) permeated the hard coat layer.

(Step (4): Curing of Layer (a))

Subsequently to the heating, an opposite side to the surface covered with the layer (a) of the substrate was irradiated with ultraviolet rays having an illuminance of 100 mW/cm² and an irradiation amount of 300 mJ/cm² by using an air cooling metal halide lamp (manufactured by Eye Graphics Co., Ltd.) of 160 W/cm while purging was performed with nitrogen such that the atmosphere had an oxygen concentration of 0.01 vol % or less, so as to cure the layer (a). After the step (4), the film thicknesses of the layer (a) and the pressure sensitive adhesive layer (the layer (b)) before the step (5) was performed were as presented in the column of “Step (4)” of Table 1.

In this manner, the laminate was manufactured.

Here, in a case where the side coated with the layer (a) was irradiated with ultraviolet rays, the layer (a) was not cured.

(Step (5): Peeling of Pressure Sensitive Film)

The pressure sensitive film was peeled off from the prepared laminate. After the pressure sensitive film (film obtained by peeling off the release film from MASTACK TFB AS3-304) was peeled off, methyl isobutyl ketone was applied to the surface to which the pressure sensitive film had been bonded, so as to wash out the residue of the pressure sensitive adhesive layer. Thereafter, the film was dried at 25° C. for 10 minutes to obtain an antireflection film 1.

(Preparation of Protective Film A)

<Synthesis of Acrylic Copolymer 1>

Nitrogen gas was introduced to a reaction device equipped with a stirrer, a thermometer, a reflux condenser, and a nitrogen introduction pipe, such that the air in the reaction device was replaced with nitrogen gas. Thereafter, 60 parts by mass of isooctyl acrylate, 20 parts by mass of isocetyl acrylate, 20 parts by mass of 4-hydroxybutyl acrylate, and 100 parts by mass of a solvent (ethyl acetate) were added in the reaction device. Thereafter, 0.1 parts by mass of azobisisobutyronitrile as a polymerization initiator was added dropwise over 2 hours, and reaction was performed at 65° C. for eight hours so as to obtain a solution of an acrylic copolymer 1 having a weight-average molecular weight of 700,000.

<Preparation of Pressure Sensitive Adhesive Composition and Protective Film A>

2.5 parts by mass of CORONATE HL and 0.1 parts by mass of dioctyltin dilaurate were added to the solution of the acrylic copolymer 1 synthesized above (at this point, 100 parts by mass of the acrylic copolymer) and were stirred and mixed, so as to obtain a pressure sensitive adhesive composition.

A release film consisting of a silicone resin-coated polyethylene terephthalate (PET) film was coated with this pressure sensitive adhesive composition, and the solvent was removed by drying at 90° C., so as to obtain a laminate in which the thickness of the pressure sensitive adhesive layer was 20 μm.

Thereafter, the pressure sensitive adhesive layer was transferred to a surface opposite to an antistatic and antifouling-treated surface of a polyethylene terephthalate (PET) film (support) which had been subjected to antistatic and antifouling treatment on one side, so as to obtain a protective film A.

(Preparation of Protective Film B)

<Synthesis of Acrylic Copolymer 2>

Nitrogen gas was introduced to a reaction device equipped with a stirrer, a thermometer, a reflux condenser, and a nitrogen introduction pipe, such that the air in the reaction device was replaced with nitrogen gas. Thereafter, 70 parts by mass of isooctyl acrylate, 20 parts by mass of isocetyl acrylate, 10 parts by mass of 4-hydroxybutyl acrylate, and 100 parts by mass of a solvent (ethyl acetate) were added in the reaction device. Thereafter, 0.1 parts by mass of azobisisobutyronitrile as a polymerization initiator was added dropwise over two hours, and reaction was performed at 65° C. for eight hours so as to obtain a solution of an acrylic copolymer 2 having a weight-average molecular weight of 700,000.

<Preparation of Pressure Sensitive Adhesive Composition and Protective Film B>

2.5 parts by mass of CORONATE HL and 0.1 parts by mass of dioctyltin dilaurate were added to the solution of the acrylic copolymer 2 synthesized above (at this point, 100 parts by mass of the acrylic copolymer) and were stirred and mixed, so as to obtain a pressure sensitive adhesive composition.

A release film consisting of a silicone resin-coated polyethylene terephthalate (PET) film was coated with this pressure sensitive adhesive composition, and the solvent was removed by drying at 90° C., so as to obtain a laminate in which the thickness of the pressure sensitive adhesive layer was 20 μm.

Thereafter, the pressure sensitive adhesive layer was transferred to a surface opposite to an antistatic and antifouling-treated surface of a polyethylene terephthalate (PET) film (support) which had been subjected to antistatic and antifouling treatment on one side, so as to obtain a protective film B.

(Preparation of Protective Film C)

In the preparation of the pressure sensitive film B, a protective film C was prepared in the same manner except that the amount of CORONATE HL to be mixed with the solution of the acrylic copolymer 2 was set as 3.7 parts by mass.

(Preparation of Protective Film D)

In the preparation of the pressure sensitive film B, a protective film D was prepared in the same manner except that the amount of CORONATE HL to be mixed with the solution of the acrylic copolymer 2 was set as 5.5 parts by mass.

(Preparation of Protective Film E)

In the preparation of the pressure sensitive film B, a protective film E was prepared in the same manner except that the amount of CORONATE HL to be mixed with the solution of the acrylic copolymer 2 was set as 8.0 parts by mass.

The antireflection films 2 to 14 were prepared in the same manner as the preparation of the antireflection film 1 except that the kind of the composition for forming the layer (a) and the kind of the pressure sensitive film as in Table 1. In addition, as described above, the pressure sensitive film was a laminate which was obtained by peeling off the release film from the protective film and which consists of the support and the pressure sensitive adhesive layer. The types of protective film used are presented in Table 1.

Except for the above, the protective film used was as below.
MASTACK TFB AS3-306 (manufactured by Fujimori Kogyo Co., Ltd., Optical protective film with antistatic function) (hereinafter also referred to as “AS3-306”)

Support: Polyester film (thickness: 38 μm)

Thickness of pressure sensitive adhesive layer: 20 μm

Maximum transmittance at wavelength of 250 nm to 300 nm in state in which release film was peeled: Less than 0.1%
MASTACK TFB AS3-310 (manufactured by Fujimori Kogyo Co., Ltd., Optical protective film with antistatic function) (hereinafter also referred to as “AS3-310”)

Support: Polyester film (thickness: 38 μm)

Thickness of pressure sensitive adhesive layer: 15 μm

Maximum transmittance at wavelength of 250 nm to 300 nm in state in which release film was peeled: Less than 0.1%

(Method of Evaluating Antireflection Film)

Various properties of the antireflection film were evaluated by the following method. Results thereof are as presented in Tables 1 and 2.

(Measuring of Surface Free Energy of Surface of Cured Layer (a) and Surface Free Energy of Surface of Pressure Sensitive Adhesive Layer)

The surface free energy (ca) of the surface of the cured layer (a) (the layer (ca)) and the surface free energy (b) of the surface of the pressure sensitive adhesive layer were respectively measured by the above method, and the difference thereof was calculated, so as to obtain a Δ surface free energy. In Table 1, the surface free energy (ca) of the surface of the cured layer (a) was presented in the section of the layer (a) of the section of the step (1), for convenience.

With respect to the obtained antireflection film, 10 μm×10 μm in the plane was observed in three visual fields with a scanning electron microscope (SEM), it was checked that a moth eye structure was formed with all the films, and the proportion of the number of particles (a2) in state in which a plurality of kinds thereof are not present in a direction orthogonal to the surface in an overlapped manner was 90% or more.

(Gel Fraction of Pressure Sensitive Adhesive)

The pressure sensitive adhesive layer was peeled off from each of the pressure sensitive films, 0.2 g was weighed (set as a metric value A). 30 g of tetrahydrofuran (THF) was added to this, was stirred for five minutes, and was left for 12 hours. A polytetrafluoroethylene (PTFE) membrane filter having a hole diameter of 10 μm (manufactured by Nippon Millipore) was prepared in advance, and a mass of the filter was measured (set as a metric value B). The THF solution was filtrated by using this filter. The filter after the filtration was dried for two hours at 100° C., and after being left for 30 minutes at 25° C., a mass thereof was measured (set as a metric value C). The gel fraction (insoluble matter to THF) was calculated from the following equation by using each of the metric values.

Gel fraction=100×(C−B)/A

The measurement was performed 3 times, and the average value thereof was used.

(Integrated Reflectance and Reflection Tint b*)

After the pressure sensitive film was peeled off in the step (5), with respect to the antireflection film before and after washing with methyl isobutyl ketone (MIBK), in a state in which the back side (substrate side) of the film was roughened with sandpaper, an oily black ink (magic ink for supplement: Teranishi Chemical Industry Co., Ltd.) was applied such that backside reflection was eliminated, an adapter ARV-474 was attached to a spectrophotometer V-550 (manufactured by JASCO Corporation), in the wavelength range of 380 to 780 nm, the integrated reflectance at an incidence angle of 5° was measured, and the average reflectance was calculated, so as to evaluate the antireflection properties. It is preferable that the integrated reflectance after washing with MIBK is 1.5% or less, since the glare was less.

The reflection tint under the D65 light source from the reflection spectrum obtained by the above measurement was calculated as a* and b* values. The change in the b* values before and after washing with MIBK after the pressure sensitive film was peeled represents an amount of a transferred product from the pressure sensitive adhesive. It is preferable that the change in the b* value before and after washing with MIBK is 6 or less, since change in appearance is small.

(Haze)

The uniformity of the surface was evaluated by a haze value. The total haze value (%) of the obtained antireflection film was measured in accordance with JIS-K7136 (2000). A haze meter NDH4000 manufactured by Nippon Denshoku Industries Co., Ltd. was used in the device. In a case where a particle aggregated and was not homogeneous, the haze was high. It is preferable that the haze was lower.

(Measurement of Contact Angle of Water)

The contact angle of water on the surface of the antireflection film before washing with methyl isobutyl ketone (MIBK) was measured by the above method (method described in the measurement of surface free energy).

(Evaluation of Muddiness)

A black polyethylene terephthalate sheet with pressure sensitive adhesive (manufactured by Tomoegawa Paper Co., Ltd.; “Kukkiri-mieru”) was laminated on the surface opposite to the side provided with the coating layer of the substrate, so as to manufacture a 30 cm×30 cm of sample in which light reflection on the back side was prevented. This sample was diagonally irradiated on the surface of the sample with a desk lamp equipped with a three-wavelength fluorescent lamp (FL20SS/EX-N/18 (manufactured by Matsushita Electric Industrial Co., Ltd.)), and the muddiness observed at this point was visually evaluated.

A: Muddiness was not visible even though the sample was carefully observed

B: Whiteness was slightly visible in a case where the sample was carefully observed

C: Muddiness was slightly visible on the entire film

D: Muddiness was strongly visible on the entire film at a glance

(Evaluation of Storage Modulus of Elasticity of Pressure Sensitive Adhesive)

A plurality of sheets of pressure sensitive tapes were overlapped and bonded, autoclaving was performed at 60° C.×0.5 MPa×30 minutes, so as to prepare a sample for a dynamic viscoelasticity test piece having a thickness of 1 mm. The sample was subjected to the dynamic viscoelasticity test in a shear rheometer (AntonPaar GmbH; device name MCR301) at a linear area, under the condition of a frequency of 1 Hz. The measuring of the storage modulus of elasticity was performed in the temperature range of −40° C. to +150° C., under the condition of the heating rate of 3° C./min, and the value at 30° C. was read.

(Weight-Average Molecular Weight (Mw) of Sol Component of Pressure Sensitive Adhesive)

The dissolution amount in THF after the pressure sensitive adhesive was immersed for 12 hours in tetrahydrofuran (THF) at 25° C. was analyzed by gel permeation chromatography (GPC), and the weight-average molecular weight was measured, so as to obtain the weight-average molecular weight of the sol component of the pressure sensitive adhesive.

TABLE 1

| | | | | | | Step (2) | | | | | | | | | | | |
|---|---|---|---|---|---|---|---|---|---|---|---|---|---|---|---|---|---|
| | | | | | | Pressure sensitive film | | | | | | | | Step (4) | | | |
| | Step (1) | | | | | | Film | Gel | | | | | | | Film | | |
| | | | | Layer (a) | | | thickness | fraction | | | | | | | thickness | | |
| | | | | | Surface | | of | of | | Surface | Storage | | Δ | | of | Step (5) | |
| | | Silica | Average | | free | | pressure | pressure | | free | modulus | | Surface | Film | pressure | Peeling of | |
| | Composition | particle | primary | | energy | Type of | sensitive | sensitive | Amount of | energy | of | | free | thickness | sensitive | pressure | |
| Antireflection | for forming | dispersion | diameter | Film | (ca) | protective | adhesive | adhesive | crosslinking | (b) | elasticity | Mw of sol | energy | of layer | adhesive | sensitive | |
| film | layer (a) | liquid | particle | thickness | (mN/m) | film | layer | (%) | agent * | (mN/m) | (Pa) | component | (mN/m) | (a) | layer | adhesive layer | Remark |
| 1 | A-1 | PA-1 | 181 nm | 200 nm | 25.5 | AS3-304 | 20 μm | 97.9% | — | 29.4 | 1.2 × 10⁵ | 20000 | −3.9 | 50 nm | 20 μm | Peeling of | Example |
| | | | | | | | | | | | | | | | | protective film | |
| 2 | A-1 | PA-1 | 181 nm | 200 nm | 25.5 | — | — | — | — | — | — | — | — | 60 nm | — | None | Comparative |
| | | | | | | | | | | | | | | | | | Example |
| 3 | A-1 | PA-1 | 181 nm | 200 nm | 25.5 | AS3-306 | 20 μm | 94.8% | — | 25.9 | 0.8 × 10⁵ | 38000 | −0.4 | 50 nm | 20 μm | Peeling of | Comparative |
| | | | | | | | | | | | | | | | | protective film | Example |
| 4 | A-1 | PA-1 | 181 nm | 200 nm | 25.5 | AS3-310 | 15 μm | 96.0% | — | 29.2 | 1.1 × 10⁵ | 25000 | −3.7 | 50 nm | 15 μm | Peeling of | Example |
| | | | | | | | | | | | | | | | | protective film | |
| 5 | A-1 | PA-1 | 181 nm | 200 nm | 25.5 | A | 20 μm | 96.5% | 2.5 | 45 | 1.1 × 10⁵ | 22000 | −19.5 | 50 nm | 20 μm | Peeling of | Comparative |
| | | | | | | | | | | | | | | | | protective film | Example |
| 6 | A-2 | PA-1 | 181 nm | 200 nm | 38.1 | AS3-304 | 20 μm | 97.9% | — | 29.4 | 1.2 × 10⁵ | 20000 | 8.7 | 50 nm | 20 μm | Peeling of | Example |
| | | | | | | | | | | | | | | | | protective film | |
| 7 | A-2 | PA-1 | 181 nm | 200 nm | 38.1 | AS3-306 | 20 μm | 94.8% | — | 25.9 | 0.8 × 10⁵ | 38000 | 12.2 | 50 nm | 20 μm | Peeling of | Comparative |
| | | | | | | | | | | | | | | | | protective film | Example |
| 8 | A-2 | PA-1 | 181 nm | 200 nm | 38.1 | AS3-310 | 15 μm | 96.0% | — | 29.2 | 1.1 × 10⁵ | 25000 | 8.9 | 50 nm | 15 μm | Peeling of | Example |
| | | | | | | | | | | | | | | | | protective film | |
| 9 | A-2 | PA-1 | 181 nm | 200 nm | 38.1 | A | 20 μm | 96.5% | 2.5 | 45 | 1.1 × 10⁵ | 22000 | −6.9 | 50 nm | 20 μm | Peeling of | Example |
| | | | | | | | | | | | | | | | | protective film | |
| 10 | A-1 | PA-1 | 181 nm | 200 nm | 25.5 | B | 20 μm | 97.5% | 2.5 | 27.5 | 1.2 × 10⁵ | 12000 | −2 | 50 nm | 20 μm | Peeling of | Example |
| | | | | | | | | | | | | | | | | protective film | |
| 11 | A-1 | PA-1 | 181 nm | 200 nm | 25.5 | C | 20 μm | 98.3% | 3.7 | 29 | 1.4 × 10⁵ | 9000 | −3.5 | 50 nm | 20 μm | Peeling of | Example |
| | | | | | | | | | | | | | | | | protective film | |
| 12 | A-1 | PA-1 | 181 nm | 200 nm | 25.5 | D | 20 μm | 99.2% | 5.5 | 29.5 | 1.4 × 10⁵ | 6000 | −4 | 50 nm | 20 μm | Peeling of | Example |
| | | | | | | | | | | | | | | | | protective film | |
| 13 | A-1 | PA-1 | 181 nm | 200 nm | 25.5 | E | 20 μm | 98.4% | 8.0 | 29.8 | 1.6 × 10⁵ | 4000 | −4.3 | 50 nm | 20 μm | Peeling of | Example |
| | | | | | | | | | | | | | | | | protective film | |
| 14 | A-3 | PA-1 | 181 nm | 200 nm | 28.9 | E | 20 μm | 98.4% | 8.0 | 29.8 | 1.6 × 10⁵ | 4000 | −0.9 | 50 nm | 20 μm | Peeling of | Example |
| | | | | | | | | | | | | | | | | protective film | |

* The amount of the crosslinking agent represents the amount (parts by mass) with respect to 100 parts by mass of the acrylic copolymer.

TABLE 2

| | | Δ Reflection tint b* before and | | | Contact | |
|---|---|---|---|---|---|---|
| | | after washing with MIBK | | | angle of | |
| Antireflection | Integrated | (corresponding to amount of | Haze | | Water | |
| film | reflectance | transferred product) | (%) | Muddiness | (°) | Remark |
| 1 | 1.0% | 4.5 | 1.8 | A | 115 | Example |
| 2 | 2.2% | 0.0 | 4.1 | D | 98 | Comparative |
| | | | | | | Example |
| 3 | 0.9% | 7.2 | 1.8 | A | 115 | Comparative |
| | | | | | | Example |
| 4 | 0.9% | 5.9 | 1.8 | A | 115 | Example |
| 5 | 1.9% | 5.5 | 3.5 | C | 112 | Comparative |
| | | | | | | Example |
| 6 | 1.3% | 4.4 | 2.5 | B | 62 | Example |
| 7 | 1.7% | 7.9 | 3.2 | C | 64 | Comparative |
| | | | | | | Example |
| 8 | 1.4% | 6.0 | 2.4 | B | 62 | Example |
| 9 | 1.2% | 5.3 | 2.3 | B | 62 | Example |
| 10 | 0.9% | 4.0 | 1.7 | A | 118 | Example |
| 11 | 1.0% | 2.2 | 1.9 | A | 115 | Example |
| 12 | 1.1% | 0.8 | 1.9 | B | 115 | Example |
| 13 | 1.1% | 0.0 | 1.9 | B | 115 | Example |
| 14 | 0.8% | 0.0 | 1.7 | A | 83 | Example |

### Example 2

In the preparation of the protective films A to E, a pressure sensitive film was transferred to one surface of ZRT60 (manufactured by Fujifilm Corporation) instead of an antistatic and antifouling-treated polyethylene terephthalate (PET) film as the substrate for transferring a pressure sensitive sheet, so as to obtain protective films F to J having the lamination configuration of “ZRT60/pressure sensitive adhesive layer/release film (PET film coated with silicone resin)”.

Maximum transmittance of the protective films F to J at wavelength of 250 nm to 300 nm in state (that is, a state of the pressure sensitive film) in which the release film was peeled was 70% to 74%.

In the antireflection films 9 to 13, the antireflection films 15 to 19 were obtained in the same manner, except that the protective films F to J were used instead of using the protective films A to E, the irradiation was performed on the surface coated with the layer (a) of the substrate with ultraviolet rays having the illuminance of 200 mW/cm² and in an irradiation amount of 300 mJ/cm² in the step (4) of curing the layer (a).

These films can be cured by using a pressure sensitive film in which a maximum transmittance at a wavelength of from 250 nm to 300 nm was 20% or more, regardless of the exposure from the pressure sensitive film side, the layer (a) may be cured, so as to obtain the same performance as the antireflection films 9 to 13. Since the exposure may be performed on the coating surface side, the manufacturing facility was able to be simplified.

### Example 3

(Preparation of Composition for Forming Hard Coat Layer)

Each component was added in the following composition, and the obtained composition was introduced to a mixing tank, stirred, and filtrated with a polypropylene filter having a pore size 0.4 μm so as to obtain a hard coat layer coating liquid HC-2.

(Hard Coat Layer Coating Liquid HC-2)

| | | |
|---|---|---|
| A-TMMT | 24.1 | parts by mass |
| AD-TMP | 11.8 | parts by mass |
| DPCA-60 | 12.0 | parts by mass |
| IRGACURE 127 | 2.1 | parts by mass |
| AS-1 | 6.9 | parts by mass |
| Ethanol | 0.4 | parts by mass |
| Methanol | 6.7 | parts by mass |
| 1-Butanol | 4.8 | parts by mass |
| Methyl ethyl ketone (MEK) | 16.8 | parts by mass |
| Methyl acetate | 14.4 | parts by mass |
| FP-1 | 0.05 | parts by mass |

AD-TMP: ditrimethylolpropane tetraacrylate (manufactured by Shin-Nakamura Chemical Co., Ltd., NK ESTER)
DPCA-60: Polyfunctional acrylate oligomer containing caprolactone structure (manufactured by Nippon Kayaku Co., Ltd., KAYARAD)
AS-1: A compound AS-1 corresponding the above patent document (A-6) was prepared in the same manner except that the reaction temperature and time of Synthesis Example 6 of JP4678451B were set as 70° C. and 6 hours. The completed compound AS-1 was a quaternary ammonium salt polymer having an ethylene oxide chain, and the weight-average molecular weight measured by GPC was about 60,000.
FP-1: Methyl ethyl ketone solution of a fluorine-containing compound represented by the following formula, and the solid content concentration was 40 mass %.

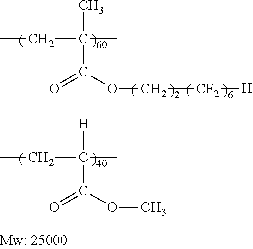

[Synthesis of Silica Particle P4]

A silica particle P4 was obtained in the same method as in the silica particle P1 except that the dropwise addition time of the solution from the dropwise adding device while the temperature in the reactor was maintained at 33° C. was changed to 37 minutes, and the stirring time while the temperature of the liquid was maintained at the same temperature after the dropwise addition was completed was changed to 37 minutes.

The average primary particle diameter of the silica particle P4 was 170 nm, the dispersion degree (CV value) of the particle diameter was 7.0%, and the indentation hardness was 340 MPa.

[Synthesis of Silica Particle P5]

A silica particle P5 was obtained in the same method as in the silica particle P1 except that, the dropwise addition time of the solution from the dropwise adding device was changed to 31 minutes while the temperature in the reactor was maintained at 33° C., and the stirring time while the temperature of the liquid was maintained at the same temperature after the dropwise addition was completed was changed to 31 minutes.

The average primary particle diameter of the silica particle P5 was 160 nm, the dispersion degree (CV value) of the particle diameter was 9.0%, and the indentation hardness was 340 MPa.

[Synthesis of Silica Particle P6]

A silica particle P6 was obtained in the same method as in the silica particle P1 except that, while the temperature in the reactor was maintained at 33° C., the dropwise addition time of the solution from the dropwise adding device was changed to 25 minutes, and the stirring time while the temperature of the liquid was maintained at the same temperature after the dropwise addition was completed was changed to 25 minutes.

The average primary particle diameter of the silica particle P6 was 150 nm, the dispersion degree (CV value) of the particle diameter was 11.0%, and the indentation hardness was 340 MPa.

[Preparation of Calcined Silica Particle P7]

A calcined silica particles P7 was obtained in the same manner as that of the calcined silica particle P2 except that the silica particle P4 was used instead of the silica particle P1.

[Preparation of Calcined Silica Particle P8]

A calcined silica particles P8 was obtained in the same manner as that of the calcined silica particle P2 except that the silica particle P5 was used instead of the silica particle P1.

[Preparation of Calcined Silica Particle P9]

A calcined silica particles P9 was obtained in the same manner as that of the calcined silica particle P2 except that the silica particle P6 was used instead of the silica particle P1.

[Preparation of Silane Coupling Agent-Treated Silica Particle P10]

A silane coupling agent-treated silica particle P10 was obtained in the same manner as the silane coupling agent-treated silica particle P3, except that the calcined silica particle P4 was used instead of the calcined silica particle P2, and the dropwise addition amount of 3-acryloxypropyltrimethoxysilane (KBM 5103 manufactured by Shin-Etsu Chemical Co., Ltd.) was changed to 50 g.

The average primary particle diameter of the silane coupling agent treated silica particle P10 was 171 nm, the dispersion degree (CV value) of the particle diameter was 7.0%, and the indentation hardness was 470 MPa.

[Preparation of Silane Coupling Agent-Treated Silica Particle P11]

A silane coupling agent-treated silica particle P11 was obtained in the same manner as the silane coupling agent-treated silica particle P3, except that the calcined silica particle P5 was used instead of the calcined silica particle P2, and the dropwise addition amount of 3-acryloxypropyltrimethoxysilane (KBM 5103 manufactured by Shin-Etsu Chemical Co., Ltd.) was changed to 57 g.

The average primary particle diameter of the silane coupling agent treated silica particle P11 was 161 nm, the dispersion degree (CV value) of the particle diameter was 9.0%, and the indentation hardness was 470 MPa.

[Preparation of Silane Coupling Agent-Treated Silica Particle P12]

A silane coupling agent-treated silica particle P12 was obtained in the same manner as the silane coupling agent-treated silica particle P3, except that the calcined silica particle P6 was used instead of the calcined silica particle P2, and the dropwise addition amount of 3-acryloxypropyltrimethoxysilane (KBM 5103 manufactured by Shin-Etsu Chemical Co., Ltd.) was changed to 65 g.

The average primary particle diameter of the silane coupling agent treated silica particle P12 was 151 nm, the dispersion degree (CV value) of the particle diameter was 11.0%, and the indentation hardness was 470 MPa.

[Preparation of Silica Particle Dispersion Liquid PA-2]

A silica particle dispersion liquid PA-2 (concentration of solid content: 20 mass %) was manufactured in the same manner as the silica particle dispersion PA-1, except that the silane coupling agent-treated silica particle P10 was used instead of the silane coupling agent-treated silica particle P3.

[Preparation of Silica Particle Dispersion Liquid PA-3]

A silica particle dispersion liquid PA-3 (concentration of solid content: 20 mass %) was manufactured in the same manner as the silica particle dispersion PA-1, except that the silane coupling agent-treated silica particle P1 was used instead of the silane coupling agent-treated silica particle P3.

[Preparation of Silica Particle Dispersion Liquid PA-4]

A silica particle dispersion liquid PA-4 (concentration of solid content: 20 mass %) was manufactured in the same manner as the silica particle dispersion PA-1, except that the silane coupling agent-treated silica particle P12 was used instead of the silane coupling agent-treated silica particle P3.

[Preparation of Composition for Forming Layer (a)]

Each component was introduced to a mixing tank so as to have the composition, was stirred for 60 minutes, and was dispersed by an ultrasonic disperser for 30 minutes to obtain a coating liquid.

Composition (A-4)

| | | |
|---|---|---|
| U-15HA | 1.4 | parts by mass |
| Compound C3 | 1.5 | parts by mass |
| Acetyl triethyl citrate | 5.8 | parts by mass |
| IRGACURE 127 | 0.2 | parts by mass |
| Compound P | 0.1 | parts by mass |
| Silica particle dispersion liquid PA-1 | 32.3 | parts by mass |
| Compound A | 0.1 | parts by mass |
| Ethanol | 12.7 | parts by mass |
| Methyl ethyl ketone | 33.3 | parts by mass |
| Acetone | 12.7 | parts by mass |

Composition (A-5)

| | | |
|---|---|---|
| U-15HA | 1.4 | parts by mass |
| Compound C3 | 1.5 | parts by mass |
| Acetyl triethyl citrate | 5.8 | parts by mass |
| IRGACURE 127 | 0.2 | parts by mass |
| Compound P | 0.1 | parts by mass |
| Silica particle dispersion liquid PA-2 | 32.3 | parts by mass |
| Compound A | 0.1 | parts by mass |
| Ethanol | 12.7 | parts by mass |
| Methyl ethyl ketone | 33.3 | parts by mass |
| Acetone | 12.7 | parts by mass |

Composition (A-6)

| | | |
|---|---|---|
| U-15HA | 1.4 | parts by mass |
| Compound C3 | 1.5 | parts by mass |
| Acetyl triethyl citrate | 5.8 | parts by mass |
| IRGACURE 127 | 0.2 | parts by mass |
| Compound P | 0.1 | parts by mass |
| Silica particle dispersion liquid PA-3 | 32.3 | parts by mass |
| Compound A | 0.1 | parts by mass |
| Ethanol | 12.7 | parts by mass |
| Methyl ethyl ketone | 33.3 | parts by mass |
| Acetone | 12.7 | parts by mass |

Composition (A-7)

| | | |
|---|---|---|
| U-15HA | 1.4 | parts by mass |
| Compound C3 | 1.5 | parts by mass |
| Acetyl triethyl citrate | 5.8 | parts by mass |
| IRGACURE 127 | 0.2 | parts by mass |
| Compound P | 0.1 | parts by mass |
| Silica particle dispersion liquid PA-4 | 32.3 | parts by mass |
| Compound A | 0.1 | parts by mass |
| Ethanol | 12.7 | parts by mass |
| Methyl ethyl ketone | 33.3 | parts by mass |
| Acetone | 12.7 | parts by mass |

U-15HA, the compound C3, and acetyl triethyl citrate were the curable compound (a1). Among them, acetyl triethyl citrate was a compound without a polymerizable functional group.

The compounds used are provided below.

Acetyl triethyl citrate, manufactured by Tokyo Chemical Industry Co., Ltd.

Other compounds are the same as those used in Example 1.

<Preparation of Antireflection Film 20>

(Forming of Substrate HC-2 with Hard Coat Layer)

The substrate (TG60, manufactured by Fujifilm Corporation) was coated with the hard coat layer coating liquid HC-2 by using a die coater at 17.3 ml/m². After drying was performed at 90° C. for one minute, while nitrogen purging is performed so as to have an atmosphere of an oxygen concentration of approximately 1.5 vol %, irradiation is performed with ultraviolet rays in an illuminance of 200 mW/cm² and in an irradiation amount of 15 mJ/cm² by using an air cooling metal halide lamp (manufactured by Eye Graphics Co., Ltd.) of 160 W/cm so as to cure a coating layer, such that a hard coat layer having a thickness of 8 μm is formed. The substrate HC-2 with a hard coat layer was prepared in this manner.

(Step (1): Coating of Layer (a))

A hard coat layer of the substrate HC-2 with a hard coat layer was coated with the composition (A-4) by using a die coater at 2.8 ml/m² and was dried for 90 seconds at 30° C. The film thickness of the layer (a) in the step (1) was as provided in Table 3 below

(Step (1-2): Step of Curing Portion of Curable Compound (a1) in Layer (a) to Obtain Cured Compound (A1c))

While nitrogen purging was performed so as to be an atmosphere in which an oxygen concentration of 1.5 vol %, irradiation was performed from the layer (a) side at an irradiation amount of 5.0 mJ by using a high-pressure mercury lamp (manufactured by Dr. Honle AG, model number: 33351N and Part no.: LAMP-HOZ 200 D24 U 450 E), so as to cure a part of the curable compound (a1). With respect to the measurement of the irradiation amount, HEAD SENSER PD-365 was mounted on an eye ultraviolet ray integrating accumulation light meter UV METER UVPF-A manufactured by Eye Graphics, Inc., and the measurement was performed in a measurement range of 0.00.

(Step (2): Bonding of Pressure Sensitive Film)

Subsequently, the pressure sensitive layer obtained by peeling off a release film from AS3-304 was bonded to the dried layer (a) such that the pressure sensitive adhesive layer (layer (b)) became the layer (a) side. The bonding was performed at a speed of 1 by using a commercial laminator Bio330 (manufactured by DAE-EL Co.)

The protective film herein refers to a laminate formed of the support/the pressure sensitive adhesive layer/the release film, and a laminate obtained by peeling off the release film from the protective film and formed of the support/the pressure sensitive adhesive layer was a pressure sensitive film.

The protective film used is as below.
AS3-304

Support: Polyester film (thickness: 38 μm)

Thickness of pressure sensitive adhesive layer: 20 μm

Maximum transmittance at wavelength of 250 nm to 300 nm in state in which release film was peeled: Less than 0.1%

The transmittance was measured using a ultraviolet-visible-near infrared spectrophotometer UV3150 manufactured by Shimadzu Corporation.

(Step (3): Permeation of Curable Compound (a1) into Pressure Sensitive Adhesive Layer)

While the pressure sensitive film was bonded, the film was left at 25° C. for five minutes such that a portion of the curable compound (a1) permeates the pressure sensitive adhesive layer.

(Step (4): Curing of Layer (a))

Subsequently to the leaving, irradiation was performed with ultraviolet rays having an illuminance of 200 mW/cm² and an irradiation amount of 300 mJ/cm² over the pressure sensitive film from the surface covered with the layer (a) of the substrate by using an air cooling metal halide lamp (manufactured by Eye Graphics Co., Ltd.) of 160 W/cm while purging was performed with nitrogen such that the atmosphere had an oxygen concentration of 0.01 vol % or less, so as to cure the layer (a). After the step (4), the film thicknesses of the layer (a) and the pressure sensitive adhesive layer (layer (b)) before the step (5) was performed was performed were as presented in the section of “Step (4)” in Table 3.

In this manner, the laminate was manufactured.

(Step (5): Peeling of Pressure Sensitive Film)

A pressure sensitive film (film obtained by peeling off the release film from MASTACK TFB AS3-304) was peeled off from the prepared laminate. The layer (a) after peeling was cured to a degree of not being broken by the peeling of the pressure sensitive adhesive layer. After the pressure sensitive adhesive layer was peeled off, the surface covered with the layer (a) of the substrate was irradiated with ultraviolet rays having an illuminance of 200 mW/cm² and an irradiation amount of 300 ml/cm² by using an air cooling metal halide lamp (manufactured by Eye Graphics Co., Ltd.) of 160 W/cm while purging was performed with nitrogen such that the atmosphere had an oxygen concentration of 0.01 vol % or less, so as to cure the layer (a). After the pressure sensitive film (film obtained by peeling off the release film from MASTACK TFB AS3-304) was peeled off, methyl isobutyl ketone was applied to the surface to which the pressure sensitive film had been bonded, so as to wash out the residue of the pressure sensitive adhesive layer, drying was performed at 25° C. for 10 minutes, so as to obtain an antireflection film 20.

The antireflection films 21 to 27 were prepared in the same manner as the preparation of the antireflection film 20 except that the kind of the composition for forming the layer (a) and the kind of the pressure sensitive film changed as in Table 3. While the step (3) of the antireflection film 20 was changed such that the pressure sensitive film was heated at 120° C. for 15 minutes while the pressure sensitive film was bonded, a portion of the curable compound (a1) permeated the hard coat layer, so as to prepare an antireflection film 28.

<Preparation of Antireflection Film 29>

(Manufacturing of Separator A)

Propylene glycol monomethyl ether acetate was added to ACRIT 8SS-1024 which was the lubricant a (crosslinking group equivalent: 263, the number of functional groups: 3 or more, manufactured by Taisei Fine Chemical Co., Ltd.) so that the solid content becomes 3 mass %, a coating solution was prepared, and this coating solution was coated on one side of a PET film substrate having a thickness of 19 μm with a wire bar #2, so as to obtain a coated film. The above coating film was dried in a hot air oven under the conditions of 80° C. and 180 seconds, to obtain a separator A.

(Preparation of Pressure Sensitive Adhesive Composition and Protective Film F)

2.5 parts by mass of CORONATE HL and 0.1 parts by mass of dioctyltin dilaurate were added to the solution of the acrylic copolymer 2 synthesized above (at this point, 100 parts by mass of the acrylic copolymer) and were stirred and mixed, so as to obtain a pressure sensitive adhesive composition.

After this pressure sensitive adhesive composition was applied to a surface opposite to the antistatic and antifouling-treated surface of the polyethylene terephthalate (PET) film (support) of which one surface was subjected to the antistatic and antifouling treatment, the solvent was removed by drying at 90° C., so as to obtain a laminate of which the thickness of the pressure sensitive adhesive layer was 20 μm. Thereafter, the pressure sensitive adhesive layer side of the obtained laminate was bonded to the surface of the separator A to which the lubricant a was applied so as to obtain a protective film F.

An antireflection film 29 was manufactured in the same manner as the antireflection film 22 except that the protective film F was used instead of the protective film B.

<Preparation of Antireflection Film 30>

[Preparation of composition for forming layer (a)] Each component was introduced to a mixing tank so as to have the composition, was stirred for 60 minutes, and was dispersed by an ultrasonic disperser for 30 minutes to obtain a coating liquid.

Composition (A-8)

| | | |
|---|---|---|
| U-15HA | 1.4 | parts by mass |
| Compound C3 | 1.5 | parts by mass |
| Acetyl triethyl citrate | 5.8 | parts by mass |
| IRGACURE 127 | 0.2 | parts by mass |
| Compound P | 0.1 | parts by mass |
| Silica particle dispersion liquid PA-1 | 32.3 | parts by mass |
| Compound A | 0.1 | parts by mass |
| ACRIT 8SS-1024 (lubricant a) | 1.0 | part by mass |
| Ethanol | 12.7 | parts by mass |
| Methyl ethyl ketone | 33.3 | parts by mass |
| Acetone | 12.7 | parts by mass |

A antireflection film 30 was manufactured in the same manner as in the antireflection film 22 except that the composition (A-8) was used instead of the composition (A-4).

<Preparation of Antireflection Film 31>

(Synthesis of Acrylic Copolymer 3)

Nitrogen gas was introduced to a reaction device equipped with a stirrer, a thermometer, a reflux condenser, and a nitrogen introduction pipe, such that the air in the reaction device was replaced with nitrogen gas. Thereafter, 85 parts by mass of isooctyl acrylate, 10 parts by mass of isocetyl acrylate, 5 parts by mass of 6-hydroxybutyl acrylate, and 100 parts by mass of a solvent (ethyl acetate) were added in the reaction device. Thereafter, 0.1 parts by mass of azobisisobutyronitrile as a polymerization initiator was added dropwise over two hours, and reaction was performed at 65° C. for 16 hours so as to obtain a solution of an acrylic copolymer 3 having a weight-average molecular weight of 700,000.

(Preparation of Pressure Sensitive Adhesive Composition and Protective Film G)

2.5 parts by mass of CORONATE HL and 0.1 parts by mass of dioctyltin dilaurate were added to the solution of the acrylic copolymer 3 synthesized above (at this point, 100) parts by mass of the acrylic copolymer) and were stirred and mixed, so as to obtain a pressure sensitive adhesive composition.

A release film consisting of a silicone resin-coated polyethylene terephthalate (PET) film was coated with this pressure sensitive adhesive composition, and the solvent was removed by drying at 90° C., so as to obtain a laminate in which the thickness of the pressure sensitive adhesive layer was 20 μm.

Thereafter, the pressure sensitive adhesive layer was bonded to a surface opposite to an antistatic and antifouling-treated surface of a polyethylene terephthalate (PET) film (support) which had been subjected to antistatic and antifouling treatment on one side, so as to obtain a protective film G.

An antireflection film 31 was manufactured in the same manner as the antireflection film 22 except that the protective film G was used instead of the protective film B.

(Method of Evaluating Antireflection Film)

Various properties of the antireflection film were evaluated by the method described in Example 1.

The following evaluation was performed.

(Measurement of Dynamic Friction Coefficient)

The dynamic friction coefficient was evaluated as an index of the surface sliding properties. As the dynamic friction coefficient, a value measured by using a HEIDON-14 dynamic friction tester with a 5 mmφ stainless steel ball with a load of 30 g at a speed of 60 cm/min after the sample was humidified at 25° C. and 60% RH for two hours was used.

As a result, the dynamic friction coefficients of the samples described in Examples 22, 29, and 30 were respectively 0.50, 0.32, and 0.48.

It has been found that the method of providing the lubricant a described in Example 29 improves transferability and also efficiently improves the surface sliding properties.

Results thereof are as presented in Tables 3 and 4.
*: The amount of the crosslinking agent represents the amount (parts by mass) with respect to 100 parts by mass of the acryl copolymer.

TABLE 3

| | | | | | | Step (2) | | | | | | | | | | | |
|---|---|---|---|---|---|---|---|---|---|---|---|---|---|---|---|---|---|
| | | | | | | Pressure sensitive film | | | | | | | | Step (4) | | | |
| | Step (1) | | | | | | Film | Gel | | | | | | | Film | | |
| | | | | Layer (a) | | | thickness | fraction | | | | | | | thickness | Step (5) | |
| | | | | | Surface | | of | of | | Surface | Storage | | Δ | | of | Peeling of | |
| | | Silica | Average | | free | | pressure | pressure | | free | modulus | | Surface | Film | pressure | pressure | |
| | Composition | particle | primary | | energy | Type of | sensitive | sensitive | Amount of | energy | of | | free | thickness | sensitive | sensitive | |
| Antireflection | for forming | dispersion | diameter | Film | (ca) | protective | adhesive | adhesive | crosslinking | (b) | elasticity | Mw of sol | energy | of layer | adhesive | adhesive | |
| film | layer (a) | liquid | particle | thickness | (mN/m) | film | layer | (%) | agent * | (mN/m) | (Pa) | component | (mN/m) | (a) | layer | layer | Remark |
| 20 | A-4 | PA-1 | 181 nm | 200 nm | 26.0 | AS3-304 | 20 μm | 97.9% | — | 29.4 | 1.2 × 10⁵ | 20000 | −3.4 | 50 nm | 20 μm | Peeling of | Example |
| | | | | | | | | | | | | | | | | protective | |
| | | | | | | | | | | | | | | | | film | |
| 21 | A-4 | PA-1 | 181 nm | 200 nm | 26.0 | — | — | — | — | — | — | — | — | 60 nm | — | None | Comparative |
| | | | | | | | | | | | | | | | | | Example |
| 22 | A-4 | PA-1 | 181 nm | 200 nm | 26.0 | B | 20 μm | 97.5% | 2.5 | 27.5 | 1.2 × 10⁵ | 12000 | −1.5 | 50 nm | 20 μm | Peeling of | Example |
| | | | | | | | | | | | | | | | | protective | |
| | | | | | | | | | | | | | | | | film | |
| 23 | A-4 | PA-1 | 181 nm | 200 nm | 26.0 | D | 20 μm | 99.2% | 5.5 | 29.5 | 1.4 × 10⁵ | 6000 | −3.5 | 50 nm | 20 μm | Peeling of | Example |
| | | | | | | | | | | | | | | | | protective | |
| | | | | | | | | | | | | | | | | film | |
| 24 | A-4 | PA-1 | 181 nm | 200 nm | 26.0 | E | 20 μm | 98.4% | 8.0 | 29.8 | 1.6 × 10⁵ | 4000 | −3.8 | 50 nm | 20 μm | Peeling of | Example |
| | | | | | | | | | | | | | | | | protective | |
| | | | | | | | | | | | | | | | | film | |
| 25 | A-5 | PA-2 | 171 nm | 190 nm | 26.0 | AS3-304 | 20 μm | 97.9% | — | 29.4 | 1.2 × 10⁵ | 20000 | −3.4 | 50 nm | 20 μm | Peeling of | Example |
| | | | | | | | | | | | | | | | | protective | |
| | | | | | | | | | | | | | | | | film | |
| 26 | A-6 | PA-3 | 161 nm | 180 nm | 26.0 | AS3-304 | 20 μm | 97.9% | — | 29.4 | 1.2 × 10⁵ | 20000 | −3.4 | 50 nm | 20 μm | Peeling of | Example |
| | | | | | | | | | | | | | | | | protective | |
| | | | | | | | | | | | | | | | | film | |
| 27 | A-7 | PA-4 | 151 nm | 170 nm | 26.0 | AS3-304 | 20 μm | 97.9% | — | 29.4 | 1.2 × 10⁵ | 20000 | −3.4 | 50 nm | 20 μm | Peeling of | Example |
| | | | | | | | | | | | | | | | | protective | |
| | | | | | | | | | | | | | | | | film | |
| 28 | A-4 | PA-1 | 181 nm | 200 nm | 26.0 | AS3-304 | 20 μm | 97.9% | — | 29.4 | 1.2 × 10⁵ | 20000 | −3.4 | 50 nm | 20 μm | Peeling of | Example |
| | | | | | | | | | | | | | | | | protective | |
| | | | | | | | | | | | | | | | | film | |
| 29 | A-4 | PA-1 | 181 nm | 200 nm | 26.0 | F | 20 μm | 97.5% | 2.5 | 18.0 | 1.2 × 10⁵ | 12000 | 8.0 | 50 nm | 20 μm | Peeling of | Example |
| | | | | | | | | | | | | | | | | protective | |
| | | | | | | | | | | | | | | | | film | |
| 30 | A-8 | PA-1 | 181 nm | 200 nm | 25.0 | B | 20 μm | 97.5% | 2.5 | 27.5 | 1.2 × 10⁵ | 12000 | −2.5 | 50 nm | 20 μm | Peeling of | Example |
| | | | | | | | | | | | | | | | | protective | |
| | | | | | | | | | | | | | | | | film | |
| 31 | A-4 | PA-1 | 181 nm | 200 nm | 26.0 | G | 20 μm | 99.0% | 2.5 | 28.0 | 1.2 × 10⁵ | 5000 | −2.0 | 50 nm | 20 μm | Peeling of | Example |
| | | | | | | | | | | | | | | | | protective | |
| | | | | | | | | | | | | | | | | film | |

TABLE 4

| | | Δ Reflection tint b* | | | |
|---|---|---|---|---|---|
| | | before and after | | | |
| | | washing with MIBK | | | |
| Antire- | | (corresponding | | | |
| flection | Integrated | to amount of | Haze | Muddi- | |
| film | reflectance | transferred product) | (%) | ness | Remark |
| 20 | 0.7% | 4.0 | 1.2 | A | Example |
| 21 | 2.0% | 0.0 | 3.9 | D | Comparative |
| | | | | | Example |
| 22 | 0.7% | 2.1 | 1.3 | A | Example |
| 23 | 0.8% | 0.2 | 1.4 | A | Example |
| 24 | 0.8% | 0.0 | 1.4 | B | Example |
| 25 | 0.6% | 3.9 | 1.0 | A | Example |
| 26 | 0.7% | 3.8 | 0.9 | A | Example |
| 27 | 0.9% | 3.8 | 0.8 | A | Example |
| 28 | 1.0% | 4.4 | 1.6 | A | Example |
| 29 | 0.7% | 1.2 | 1.4 | A | Example |
| 30 | 0.7% | 2.0 | 1.3 | A | Example |
| 31 | 0.6% | 0.2 | 1.3 | A | Example |

The contact angle of water on the antireflection film 22 was 115°, the contact angle of water on the antireflection film 29 was 126°, and the contact angle of water on the antireflection film 30 was 120°.

It has been found that, in the antireflection film prepared by the manufacturing method of the present invention, the integrated reflectance was 1.5% or less, the haze was 3% or less such that suppression of muddiness is excellent, Δb* before and after washing with MIBK after peeling of the pressure sensitive film was 6 or less, and the transferred product of the pressure sensitive adhesive layer was less. The samples disclosed in the examples were able to exhibit good performance even without performing the washing step after the peeling of the pressure sensitive film.

According to the present invention, it is possible to provide a laminate that can be used for easily manufacturing an antireflection film having a satisfactory antireflection performance, low haze, and small muddiness, a method of manufacturing the laminate, and a method of manufacturing an antireflection film using the method of manufacturing the laminate.

The present invention has been described in detail and with reference to specific embodiments, but it is obvious to those skilled in the art that various changes and modifications can be made without departing from the spirit and scope of the invention.

This application is based on Japanese patent application (JP2016-055449) filed on Mar. 18, 2016 and Japanese patent application (JP2016-102776) filed on May 23, 2016, and the contents thereof are incorporated herein by reference.

### EXPLANATION OF REFERENCES

1: substrate
2: antireflection layer
3: particle (a2)
4: layer (a)
5: support
6: layer (b)
7: pressure sensitive film
8: laminate
10: antireflection film
A: distance between peaks of adjacent protrusions
B: distance between the center of peaks of adjacent protrusions and recessed part

What is claimed is:

1. A laminate comprising: a substrate; a layer (ca) comprising a resin; a particle (a2) having an average primary particle diameter of 100 nm to 380 nm; and a layer (b) comprising a pressure sensitive adhesive having a gel fraction of 95.0% or more,
wherein the layer (ca) is present closer to the substrate than the layer (b),
the particle (a2) is buried in a layer obtained by combining the layer (ca) and the layer (b) and protrudes from an interface of the layer (ca) on an opposite side of an interface of the layer (ca) on the substrate side, and
a value obtained by subtracting a surface free energy (b) of a surface of the layer (b) from a surface free energy (ca) of a surface of the layer (ca) is −15 mN/m to 10 mN/m.

2. The laminate according to claim 1, wherein the surface free energy (ca) of the surface of the layer (ca) is 40 mN/m or less, and the surface free energy (b) of the surface of the layer (b) is 40 mN/m or less.

3. The laminate according to claim 1, wherein a contact angle of water on the surface of the layer (ca) is 50° or more.

4. The laminate according to claim 1, further comprising: a support at a side of an interface of the layer (b) on an opposite side of an interface of the layer (b) on the layer (ca) side.

5. The laminate according to claim 1, wherein a height of the interface of the layer (ca) on the opposite side of the interface of the layer (ca) on the substrate side is equal to or less than a half of the average primary particle diameter of the particles (a2).

6. The laminate according to claim 1, wherein a plurality of the particles (a2) are not present in a direction orthogonal to a surface of the substrate.

7. The laminate according to claim 1, wherein the particle (a2) is a metal oxide particle.

8. The laminate according to claim 1, wherein the particle (a2) is a surface-modified particle.

9. The laminate according to claim 1, wherein a lubricant having three or more crosslinking groups in one molecule, having a crosslinking group equivalent of 450 or less, and having a moiety including at least one of a fluorine atom or a siloxane bond is present between the layer (b) and the layer (ca).

10. A method of manufacturing a laminate comprising, in order:
a step (1) of providing a curable compound (a1) and a particle (a2) having an average primary particle diameter of 100 nm to 380 nm on a substrate, in a thickness in which the particle (a2) is buried in a layer (a) comprising the curable compound (a1);
a step (2) of bonding a layer (b) of a pressure sensitive film having a support and the layer (b) comprising a pressure sensitive adhesive having a gel fraction of 95.0% or more on the support to the layer (a);
a step (3) of causing a position of an interface between the layer (a) and the layer (b) to descend to the substrate so that the particle (a2) is buried in a layer obtained by combining the layer (a) and the layer (b) and protrudes from an interface of the layer (a) on an opposite side of an interface of the layer (a) on the substrate side; and
a step (4) of curing the layer (a) in a state in which the particle (a2) is buried in the layer obtained by combining the layer (a) and the layer (b),
wherein a value obtained by subtracting a surface free energy (b) of a surface of the layer (b) from a surface free energy (ca) of a surface of the cured layer (a) is −15 mN/m to 10 mN/m.

11. The method of manufacturing a laminate according to claim 10, wherein the surface free energy (ca) of the surface of the cured layer (a) is 40 mN/m or less.

12. The method of manufacturing a laminate according to claim 10, wherein the surface free energy (b) of the surface of the layer (b) is 40 mN/m or less.

13. The method of manufacturing a laminate according to claim 10, wherein a maximum transmittance of the pressure sensitive film at a wavelength of 250 nm to 300 nm is 20% or more.

14. The method of manufacturing a laminate according to claim 10, wherein the pressure sensitive adhesive comprises a cured product of a pressure sensitive adhesive composition comprising a polymer and a crosslinking agent, and the pressure sensitive adhesive composition comprises more than 3.5 parts by mass and less than 15 parts by mass of the crosslinking agent with respect to 100 parts by mass of the polymer.

15. The method of manufacturing a laminate according to claim 14, wherein a weight-average molecular weight of a sol component in the pressure sensitive adhesive is 10,000 or less.

16. The method of manufacturing a laminate according to claim 10, wherein a storage modulus of elasticity of the pressure sensitive adhesive at 30° C. and 1 Hz is 1.3×10⁵ Pa or less, and a weight-average molecular weight of a sol component in the pressure sensitive adhesive is 10,000 or less.

17. The method of manufacturing a laminate according to claim 10, wherein a compound having three or more (meth)acryloyl groups in one molecule is included as the curable compound (a1).

18. The method of manufacturing a laminate according to claim 10, wherein the step (3) is performed by heating the laminate so as to cause a portion of the curable compound (a1) to permeate the substrate.

19. The method of manufacturing a laminate according to claim 18, wherein a temperature during the heating is 60° C. to 180° C.

20. The method of manufacturing a laminate according to claim 10, wherein the step (3) is performed by causing a portion of the curable compound (a1) to permeate the layer (b).

21. The method of manufacturing a laminate according to claim 20, wherein a temperature at which the portion of the curable compound (a1) is caused to permeate the layer (b) is less than 60° C.

22. A method of manufacturing an antireflection film comprising: a step (5) of peeling off the pressure sensitive film of the laminate obtained by the method according to claim 10.
